(19) United States
(12) Patent Application Publication
(10) Pub. No.: US 2004/0236651 A1
(43) Pub. Date: Nov. 25, 2004

(54) Methods, systems and computer program products for processing electronic documents

(76) Inventors: Martin von der Emde, Rauenberg (DE); Andreas Leukert-Knapp, Heidelberg (DE); Doris Mollgaard, Wiesloch (DE); Oliver Randschau, Leimen (DE)

Correspondence Address: Finnegan, Henderson, Farabow,, Garrett & Dunner, L.L.P., 1300 I Street, N.W,, Washington, DC, 20005-3315, US

(21) Appl. No.: 10/785,997

(22) Filed: Feb. 26, 2004

(30) Foreign Application Priority Data
Mar. 4, 2003 (DE) 10309559.4
Feb. 28, 2003 (DE) 10309171.8
Feb. 28, 2003 (DE) 10309172.6
Feb. 28, 2003 (EP) 03004483.8

(51) Int. Cl. G06F 17/60

(52) U.S. Cl. 705/34

(57) ABSTRACT

Methods, computer program products and systems are provided for processing an electronic document, wherein the document comprises a plurality of data fields. The document is made accessible by a first party. A second party may add or edit one or more of the data fields to one or more of the data fields of the documents using one or more structured documents.

### DESCRIPTION OF THE INVENTION

1. Field of the Invention

The technical field of this invention is in the area of electronic document processing. More particularly, the invention relates to methods, computer program products and systems for automated billing systems and, still more particularly, to methods, computer program products and systems for processing, generating and presenting an electronic invoice, credit memos or invoice proposals to a customer for remote review and accounting.

2. Background of the Invention

It should be understood that the term “presenting” as used herein broadly refers to the specialized definition normally associated with commercial paper (i.e., the production on a negotiable instrument to a drawee), as well as to providing information via electronic means. For example, an electronic presentation may be through the use of an Internet or intranet website or via e-mail or SMS, e.g., by making a web site accessible to one or more persons. Electronic presentation may also take place by sending computer readable storage media, like disks, ZIP disks, magneto-optical disks, CDs, R/W discs, DVD ROMs etc., e.g., via standard mail. Electronic invoices thereby containing at least the same customer billing data typically included on a paper invoice. The terms “invoice” and “bill” are hereinafter used alternatively.

The presenting party is hereinafter alternatively referred to as the first party and the person or combining to whom the invoice is presented (usually the customer), is hereinafter alternatively referred to as the second party.

Methods and systems for electronic invoice presentment and payment (EBPP) in enterprise accounting software (EAS) environments are known from the state of the art. For example, the document U.S. Pat. No. 6,044,362 discloses a system for automated electronic invoicing and payment for providing remote customer review of automated billing from an invoicer. The system includes invoice presentment electronics having a control system and first communication electronics. The system also includes at least one remote authorization terminal having a customer interface, the terminal having second communication electronics adapted to operatively communicate with the first communication electronics. The control system of the invoice presentment electronics is adapted to provide billing data, regarding a customer invoice preauthorized for automated billing, to the first communication electronics for transmission to the second communication electronics. The customer interface of the remote authorization terminal is adapted to present the billing data to a customer and to receive a response relating to the billing data from the customer, the response indicating one of acceptance of the billing data for automated billing or modification of the billing data for modifying automated billing. Acceptance can either be an active response from the customer or a passive response, for example, automatic acceptance up to a preset limit.

U.S. Pat. No. 5,465,206 discloses an invoice pay system wherein participating customers pay bills to participating billers through a payment network operating according to preset rules. The participating customers receive bills from participating billers (e.g., paper/mail bills, e-mail notices, implied bills for automatic debts) which indicate an amount, and a unique biller identification number. To authorize a remittance, that customer transmits to its bank (a participating bank) an invoice pay order indicating a payment date, a payment amount, that customer's account number with the biller, a source of fund and the biller's biller identification number, either directly or by reference to static data, containing those data elements. Bank C then submits a payment message to a payment network, and the payment network, which assigns the biller reference numbers, forwards the payment message to the biller's bank. For settlement, the customer's bank debits the customer's account and is obligated to a net position with the payment network; likewise, the biller's bank receives a net position from the payment network and credits the biller's bank account. If the customer's bank agrees to send non-reversible payment messages, that customer's bank does not submit the transaction until funds are good unless the customer's bank is willing to take the risk of loss if funds are not good, in the case of a guaranteed payment network. The biller's bank, upon receipt of the payment message, releases the funds to the biller, and provides A/R data to biller in a form which biller B has indicated, the form being one which does not have to be treated as an exception item to the biller. The biller's bank is assured of payment by the payment network, unless the transaction is a reversible transaction according to the preset rules of the payment network. In specific embodiments, the customer initiates the invoice pay orders manually, via paper at an ATM, via a personal computer (PC), or via telephone keypad.

Another system is known from the website www://ofx.net. Open Financial Exchange (ofx) is a broad-based framework for exchanging financial data and instructions between customers and their financial institutions. It allows institutions to connect directly to their customers without requiring an intermediary. Open Financial Exchange is an open specification that anyone can implement: any financial institution, transaction processor, software developer, or other party. It uses widely accepted open standards for data formatting (such as XML), connectivity (such as TCP/IP and HTTP), and security (such as SSL). Open Financial Exchange defines the request and response messages used by each financial service as well as the common framework and infrastructure to support the communication of those messages. The data of biller and customer are held in the same system.

Such computer systems and software may be used at various points of the whole process of presenting, accounting, verifying and paying a bill. Some of the available software is specialized to provide a direct interface between the computer systems of the presenting party and the customer. By means of such software, and electronic invoice may be presented to a customer by means of the Internet. To use such service, a customer only needs an Internet account, an Internet browser, and access to a EBPP software. The available software further provides functions like sending questions to the biller with respect to a specific bill, paying a bill, or downloading an invoice either as a data file for separate storage or as data for a direct entering into an EAS system of the customer. If the electronic invoice has arrived in the computer system of the customer, an approval process is initiated, which does not distinguish between the conventional approval process without EBPP. The customer processes the following traditional steps: in the logistics department, the invoice is checked against the delivery, in the accounts department, accounts and costs centers are assigned to the bill, etc. These steps are performed manually and are paper based. As soon as the necessary data are entered, the invoice may be booked. The booking may be performed manually in the booking system or automatically if a suitable EAS system is available.

However, suitable EAS systems require a lot of energy, money, hardware, software, consulting, and training of the users. Smaller companies are now in the dilemma that they have to run through thee process of approving invoices on the one hand, and on the other hand that the size of the company does not allow the installation of a complex EAS system. A further disadvantage of the installation of a complex EAS system is that the customer is bound to the system for a considerable amount of time. Consequently, the functionality of the installed EAS system is relatively fixed during that time. The scale of the software license for the EAS system has to be fixed also, so that the customer is nearly inevitably bound to a system, which is designed for a huge workload, because software licenses normally cannot be returned in times of lower workload. Further, the installation of additional functionality into an existing EAS is technically difficult and, if possible at all, cost intensive.

Thus, there is a need for methods, software applications and/or data processing systems that provide a more efficient solution of at least parts of the problems described above, particularly it is desirable to provide computer systems and/or software applications, which are suitable for the use of approving, accounting or reviewing of electronic documents, particularly bills.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

The accompanying drawings, which are incorporated in and constitute a part of this specification, illustrate one embodimentof the invention and together with the description, serve to explain the principles of the invention.

### SUMMARY OF THE INVENTION

In accordance with the invention, as embodied and broadly described herein, methods and systems according to an exemplary implementation of the invention and consistent with the principles of the invention provide for processing an electronic document, wherein the document comprises a plurality of data fields and wherein the document is made accessible by a first party to a second party via a computer network.

Consistent with embodiments of the invention, means may be provided for enabling a second party to add one or more further data fields to one or more of the data fields of the document. Such means may be implemented as selecting means, which present a list of one or more data fields to the second party for selection. The selection means may further comprise editing functionality.

Embodiments of the invention are further directed to methods for processing a electronic document, stored in a computer system of a first party, by a second party, wherein the document comprises a plurality of data fields and wherein the document is made accessible by the first party to the second party via a computer network. Consistent with such methods, the second party may access one or more structured documents presented by the first party and add and/or edit one or more further data fields to the electronic document by means of the one or more structured documents.

It should be noted in this context that the first and second parties do not necessarily have to be different legal persons. The first and second parties can also be established within one company, for example, as different departments having computer systems connected over a network. Both parties can even use the same computer system. The first and second parties can also be one and the same person.

The electronic document may contain any type of data (e.g., technical data or non-technical data). For example, it may contain data on experimental results whereby the experiments are performed by different persons (e.g., two persons) and the second person wants to add his experimental data to the data of the first person to have a common data set. As a further example, the electronic document may contain physical or chemical properties of chemical substances, whereby different parties are allowed to add further chemical or physical properties and the respective data they may have gained in experiments or edit such data. The document may, however, contain non-technical data like financial data, e.g., invoice data.

Embodiments of the invention are further directed to computer systems, computer programs, computer readable mediums and carrier signals, each comprising program code or instructions for processing documents, e.g.,bills, according to the disclosed methods and their embodiments.

Embodiments of the invention further relate to data structures, method and apparatuses for automatically processing documents, particularly invoices, using a computer system, in which an electronic document (invoice) is available with a multiplicity of data fields containing document (invoice) information, and in which the document (invoice) is made accessible to a second party by a first party.

Advantages of the invention and of the disclosed concept of providing a service for processing documents, or of releasing software for processing the documents can essentially be seen in that the disclosed method is easy to integrate into the IT systems of billers and customers. The customer merely requires a computer with network (Internet) access and a web browser.

Invoices from different billers are easy for a customer to handle, and different financial institutions as payment service providers are possible. The methods are easy to scale for a large quantity of invoices, and network-like interconnection of a plurality of service providers beyond national borders allows international invoicing, invoice presentation and payment, as well as invoice review by workflow.

In addition, fewer “professional users” are necessary for the application user, and any employee is a potential initiator of invoices and thus an auditor (e.g. for company cars). Fewer costs are incurred for training (“easy-to-use” web application (auditor)) and there is a large potential for saving costs for software and hardware and for implementation, the processes can become more streamlined and the process times can be shortened. Embodiments of the invention further address the technical problem of allowing a second party to modify, particularly to add data fields to electronic documents in the first party's computer system without giving the second party too much access rights to the first party's computer system.

Additional objects and advantages of the invention will be set forth in part in the description, or may be learned by practice of the invention. The objects and advantages of the invention will be realized and attained by means of the elements and combinations particularly pointed out in the appended claims. Embodiments of the invention are disclosed in the detailed description section and in the dependent claims.

Particular embodiments of the disclosed method and particular refinements of the disclosed apparatuses are disclosed in the respective sub claims. It is also possible for single or a plurality of or any combinations of the features disclosed in the respective sub claims in a category, together with the features of the respective main claim, to represent disclosed solutions to the object on which the invention is based.

The invention also relates to computer systems, computer programs, and computer program products for carrying out the disclosed methods.

It is understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments of the invention and, together with the description, explain the principles of the invention. In the drawings:

FIGS. 1a and 1b are block diagrams for illustrating an exemplary implementation of the claimed method by means of a computer system from the viewpoint of a first and second party, respectively;

FIG. 2 illustrates, by means of a block diagram, an example of a route taken by an electronic invoice when the disclosed method according to an exemplary implementation of the invention is used;

FIG. 3 illustrates an example of a plurality of steps when processing invoices in accordance with an exemplary implementation of the disclosed method;

FIG. 4 illustrates a block diagram of a first possible split for individual steps of an exemplary implementation of the disclosed method over one or more parties;

FIG. 5 illustrates a block diagram of a second possible split for individual steps of an exemplary implementation of the disclosed method over one or more parties;

FIG. 6 illustrates a block diagram of a third possible split for individual steps of an exemplary implementation of the disclosed method over one or more parties;

FIG. 7 illustrates a block diagram of a possible step sequence for “manual” processing of an invoice according to an exemplary implementation of the invention;

FIG. 8 illustrates a block diagram of a possible step sequence for “automatic” processing of an invoice according to an exemplary implementation of the invention;

FIG. 9 illustrates a block diagram of an example of a possible status for an electronic document;

FIG. 10 illustrates a block diagram of an example of one possible use of an exemplary implementation of the disclosed method for processing credit memos;

FIG. 11 illustrates a block diagram of an example of one possible use of an exemplary implementation of the disclosed method where a receiver of goods or services presents the service provider with an invoice proposal;

FIG. 12 illustrates, as an addition to FIG. 11, a block diagram of how the invoice proposal is processed by the service provider according to an exemplary implementation of the invention;

FIG. 13 illustrates an exemplary flow diagram of an exemplary implementation of a disclosed process of processing an electronic bill;

FIG. 14 illustrates a further exemplary flow diagram of an exemplary implementation of a disclosed process of processing an electronic bill;

FIG. 15 illustrates an exemplary flow diagram of a workflow with manual selection of further case workers; and

FIG. 16 illustrates an exemplary flow diagram of a workflow manual and automatic selection of further case workers.

### DESCRIPTION OF THE EMBODIMENTS

Reference will now be made in detail to the present exemplary embodiments of the invention, examples of which are illustrated in the accompanying drawings. Wherever possible, the same reference numbers will be used throughout the drawings to refer to the same or like parts.

Within the concept of this specification, the terms used shall have their usual meaning in the context of the field of data processing unless defined otherwise. Particularly, a computer system broadly refers to any stand alone computer such as a PC or a laptop or a series of computers connected via a network, e.g., a network within a company, or a series of computers connected via the internet. Computer systems and programs may be closely related. As used herein, phrases, such as “the computer provides,” “the program provides or performs specific actions,” and “a user performs a specific action” are used to express actions by a computer system that may be controlled by a program, to express that the program or program module may be designed to enable the computer system to perform the specific action, or to enable a user to perform the specific action by means of a computer system.

In this context, the term “automatically” is not intended to exclude a user's interactions with the computer system in the course of processing.

The disclosed methods as described in the summary section may be implemented by means of computer systems and computer software which allow the creation of business software applications and which allow the use of databases or database applications and Internet applications.

An electronic document, e.g., an electronic invoice, within the concept of this disclosure comprises a plurality of data fields, which contain information, e.g., typical billing information like invoice number, the receiver of the invoice (the customer), its address, type of sold product, number of sold products, price per product, total price, taxes, payment conditions etc., each data field may be named accordingly. Such an electronic document, e.g. an invoice, may be implemented within the software environment mentioned above as a line of a table or one or more lines of one or more tables, for example by means of a relational data base system. Such an electronic invoice, however, may also be implemented in object orientated programming languages as an instance of a class. Thus, the electronic document may also be a structured document. It is, according to an exemplary implementation of the invention, processed by means of further structured documents.

The means for enabling said second party (customer) to add one or more further data fields to the document (invoice) may be implemented for example as computer programs or program modules or functions in programs (hereinafter collectively referred to as “program” or as “eCSP” (external customer service provider, in case of invoice processing)), which are located in the computer system and software environment of the first party, but which may be called by a user of a computer system of the second party via the Internet by means of an Internet browser. These programs, if executed, present to the user of the second party one or more data fields, which the user may select and/or in which he may enter the information he desires. The information may be, in the case of invoice processing, financial information the second party needs for booking the invoice in his bookkeeping system. Such information may typically, but not limiting, comprise information for the general ledger, sub ledger, accounts payable, accounts receivable, assets accounting, information on accounts, creditors, investments, etc. The Internet browser of the second party then forwards the information to the program of the first party and the program adds the respective data fields to the invoice and writes the respective information into these fields. The number and the properties of the further data fields so presented to the second party are defined during of the installation of the eCSP.

A preferred form of presentation is the electronic presentation.

An invoice usually comprises a header section, in which the general information is contained, and a positions section, in which the information relating to the sold product is contained. Each of the other data fields, which are added to the electronic bill, may be assigned either to the header or to the positions section.

The first party and the second party can also be located within one company. The computer systems of the first and second party within one company may be connected via an intranet of the company. In a special case they may be identical.

A first embodiment of an exemplary implementation of the disclosed method comprises the first party providing means for enabling the second party to enter information into the one or more further data fields.

A second embodiment of an exemplary implementation of the disclosed method comprises the first party providing proposals for the information to the second party according to a predefinable list.

A third embodiment comprises the document as an electronic bill.

A fourth embodiment comprises the first party writing financial information into the one or more further data fields and adding the one or more further data fields to the electronic bill.

A fifth embodiment comprises selecting the financial information from the group consisting of financial objects, accounting objects, and bookkeeping objects.

A sixth embodiment comprises writing a predefinable value into one or more of the further data fields.

In a seventh embodiment, an exemplary implementation of the invention comprises means for enabling the second party to add one or more further data fields to one or more of the data fields of the document comprising one or more structured documents.

An eighth embodiment comprises the structured document containing data and/or tags and/or program code and wherein the structured document is accessible by the second party.

A further embodiment comprises a structured document that is a either a structured table, a XML-file, a HTML-file, or a java server page.

A further embodiment comprises the first party providing means for enabling the second party to characterize the bill as accepted or refused.

In a further embodiment of the disclosed method, the method comprises sending an accepted electronic bill to the second party and/or to a payment service provider.

A still further embodiment comprises creating an accounts record from an accepted bill and sending it to the second party.

A still further embodiment comprises two or more of the further data fields being structured hierarchical.

A still further embodiment comprises a property selected from the group consisting of displayable, non displayable, optionally editable, and mandatory editable, and the property is assigned to one or more of the further data fields.

A still further embodiment comprises the first party providing means for naming the one or more further data fields.

A still further embodiment of the disclosed method comprises checking the authorization of a user of the second party.

In a still further embodiment, the embodiment may provide for making the document accessible to the second party by means of an intranet or the Internet.

In a still further embodiment, the embodiment may provide for counting the processed documents and providing an invoice for the processing of the documents to the second party.

A still further embodiment comprises automatically starting a workflow for processing the bill if an electronic bill is received from a third party.

A still further embodiment comprises sending an electronic notice, which includes a link from the document to an address contained in the workflow.

A still further embodiment comprises the workflow running according to a predefinable sequence.

A still further embodiment comprises automatically checking the authorization of a participant of the workflow.

A still further embodiment is the disclosed methods, data structures, or computer systems for use in or for an enterprise resource planning software.

An enterprise resource planning software herein broadly refers to any software or software package for supporting business processes of enterprises, including but not limited to accounting, administration, management, or production processes.

The following abbreviations are used in the further explanations below:

RE: invoice receiver; RS: invoice issuer;

BSP: Biller Service Provider, a subcomponent of the ® SAP Biller Consolidator, an SAP software product for computer-implemented handling of invoices (SAP AG, Neurottstr. 16, 69190 Walldorf, Germany). The RS delivers invoices to the BSP. The BSP is operated by a company which looks after the biller's interests and provides the biller with part of the invoicing process as a service.

Consolidator: further subcomponent of the SAP Biller Consolidator. A node between, possibly, various BSPs and various eCSPs. Regulates communication between BSPs and eCSPs and manages the relationships between invoice issuers and invoice receivers.

Service Billing: billing application of the component SAP Biller Consolidator. An operator of a BSP, consolidator or eCSP can use Service Billing to charge its customer for the services provided.

The “external Customer Service Provider” or eCSP can be used, within the context of the component SAP Biller Consolidator, to display invoices and invoice information in the Internet browser and to assign them to accounts and prepare them for posting in a backend system provided for the purpose. This means that invoice receivers on the Internet see their invoice receipts for each supplier and can use these data for further processing such as approval and account assignment. Using the eCSP, the transaction costs for invoice handling can be reduced and the supply relationship can be improved, inter alia.

The eCSP eliminates the media crashes which still exist today for digital business transactions and in this regard is suitable for all companies wishing to exchange invoice information with their business partners directly or via a consolidator. In this case, it is not necessary, as with conventional EDI connections, for there to be a direct relationship between supplier and customer. In addition, the customer's operative does not need to have extensive system knowledge and training in order to be able to assign an invoice to an account, but rather enters the relevant information into a self-explanatory, simple mask in the Internet browser, whereupon the system generates a posting document which is transferred to the customer's backend system.

The eCSP supports the pull principle, i.e. the eCSP periodically fetches invoices for its customers from the appropriate consolidator, and each customer periodically fetches his invoices from his eCSP (in both cases no active sending of invoices). In this context, the invoice receiver is informed (push principle) by e-mail about changes in his account balance (new invoices or credit memos) and can then visit the CSP's web page in order to view his invoice data there, to process them and to fetch them (pull principle) in a document structure by means of download. To access this information, the invoice receiver does not need to install any kind of special software and merely requires a web browser.

The eCSP can receive invoice data and invoices and can make them available to the invoice receiver for further processing. The invoices can come from a consolidator, from an invoice issuer or from the actual invoice receiver's firm. In the eCSP, incoming invoices can be processed in digital form and can be made available for posting in document form. The inventive solution can be VAT-compliant.

The processing of invoices in the eCSP can comprise one or more of the following processing steps:

Invoices are fetched from the consolidator via a CCX interface as an XML-IDOC and as a PDF.

Besides invoices, dunning letters (correspond to the format of an invoice with appropriate identification) and credit memos can be received.

During processing of receipts, the form and content of the invoices can be checked and the invoices can be rejected if there is an error. Otherwise, a workflow and, if available, also an account assignment can be allocated.

The processed invoices can be stored on the eCSP with accounting assignments in the tables provided for the purpose. In addition, the XML invoice and the PDF invoice can also be obtained.

The invoice receiver can configure workflow, roles or users, automatic initial account assignment, and record creation. The workflow and account-assignment settings can be made for each invoice issuer.

To produce the accounting records and transfer them to a collective file (e.g., BI session), an appropriate report can be provided which can be periodically dispatched by the operator or customer. To produce other formats, a Business Add-Inn can be provided. The file can be transferred to the customer system by means of downloads.

In the eCSP, cost events can be generated. These can be transferred periodically by the operator to an invoicing application, e.g. Service Billing, so that invoices can be produced there from which can in turn be delivered to the BSP.

The eCSP can be used by employees in firms who take on different roles. These are employees with an operator of an eCSP who provide support for employees of the associated REs and, in this context, maintain master data and can monitor messages, for example. Advantageously, however, the employees are with the invoice receiver and perform the auditing and assign the invoices to accounts. A further role is played by the system administrator for the RE, who can create users and manages authorizations.

To operate the eCSP, the following user interfaces are advantageous:

Frontend for the invoice receiver's accounting employees: these use the Internet web browser to call up the eCSP's Internet address, authenticate themselves, check, and then assign the received invoices to accounts.

Frontend for the invoice receiver's system administrator.

Frontend for the eCSP operator's support employees: maintenance of the invoice receiver's master data, such as invoice issuers, invoice types, invoice item types, account-assignment information, and customizing record creation.

Supported formats: examples are XML-IDOC and UN/EDIFACT. In addition, PDF files for the invoices can also be accepted.

For the frontends, it is possible to use the most up-to-date technologies; currently, these are Java Server Pages or Web-front-end.

An invoice receiver's user requires merely a PC with Internet access and a current web browser. These need to allow him to add and remove invoice issuers, to process invoices, and to manage master data.

The eCSP can communicate with the consolidator at various points. The communication protocol used can be https and TCP/IP. In this context, the communication format understood and used by the existing consolidator should be supported at all times.

Users can authenticate themselves when accessing the eCSP, e.g. using a user ID and a password, or using certificates. The initial password of any user can be valid only for the first time he logs on, for example, and can be deactivated if the password is entered incorrectly three times.

The eCSP operator can store his name and his logo in the system once. Both can be displayed to any user logging onto the frontend for an invoice receiver in the header of the standard layout.

If the operator uses the “Service Billing” component, then he can also specify to which CRM system the created cost events need to be transferred.

If the operator makes an agreement with a new invoice receiver, then he creates an organizational unit with an identification number and master data for this new invoice receiver in the eCSP.

An organizational unit is understood to mean the smallest organizational unit of a business partner connecting to an eCSP. Users obtain their access authorizations for a particular organizational unit, and cost events are defined for each organizational unit, i.e. the operator cannot charge for his provided services on any finer basis than according to organizational units. For companies, it may thus be appropriate to have a number of organizational units set up (for example, one for each company code).

The identification number is requested by the consolidator—a corresponding XML request is already provided in the eCSP—and is allocated centrally by the consolidator. The scope of the master data is defined by the fields available in the SAP (“central”) business partner. The content of the master data has no restrictions, since all the invoice data originate from the transaction data. Every invoice receiver can be assigned a workflow pattern. When a new invoice receiver is created, the standard workflow pattern should have been preset for the “individual workflow” by default.

The consolidator to which the eCSP is connected is notified of the new invoice receiver by the eCSP, for example upon the actual request for an identification number. This function should be able to be performed fully automatically using an XML interface.

As soon as a user in an organizational unit has access to the system, he needs to be able to use a “biller list” to select from which of the connected invoice issuers he wishes to receive electronic invoices via this eCSP. These relationships are managed by the consolidator. The eCSP merely takes care of displaying the appropriate information and of communicating with the consolidator when an invoice receiver wishes to initiate or end electronic receipt of an invoice from an invoice issuer.

Accordingly, the biller list is a complete list of all connected invoice issuers which shows not only the distinct label (e.g., name, legal form, company head office), but also the status of the biller-customer relationship with this organizational unit (e.g., not connected, connected, application for connection in progress, connection rejected).

The biller list may be displayed in the eCSP. It needs to be able to be sorted upward and downward according to name and possibly company head office, and particularly needs to identify which invoice issuers have newly connected within a settable period of time. The content of the biller list is held in the consolidator and is fed to the list. A link to the invoice issuer's declaration of delegation in line with the requirements of the ESTV (Swiss Tax Administration) may be provided.

When an invoice issuer is selected by an organizational unit, the organizational unit can specify the customer number (“biller's customer number”) under which the invoice issuer manages it as the customer. This makes it easier for the invoice issuer to assign this company to his sub ledger account correctly.

The eCSP operator forwards this request from the invoice receiver to the consolidator. As soon as the consolidator sends the invoice receiver's response, the invoice receiver can be informed of this. The same happens if the RE changes his mind and subsequently wishes to receive his invoices from an RS in the conventional way again. He simply terminates his connection to this RS.

In the biller list, the status of the connected RS is constantly updated: new, application for connection in progress, connected, application for termination in progress, terminated, left etc. When a supplier has left the Biller Consolidator, he should nevertheless be provided with a note in the list for a further two months or should be highlighted in color before he is deleted from the list.

Every user can be allocated authorizations to an extent which corresponds exactly to the respective user's area of responsibility. The authorizations are used to control whether or not a user is permitted to perform a particular system transaction. This right can be granted to a user or refused for each system transaction.

Since sets of authorizations are often repeated, authorizations can be maintained using authorization profiles and the users can then be assigned one or more authorization profiles at once. Each connected organizational unit can manage its own authorization profile itself.

A user's authorization for an organizational unit can be finely tuned. Granularity can be defined in the eCSP with the following authorization objects: Invoice display (read authorizations):

Depending on invoice issuer (supplier or creditor)

Depending on sum in each currency

Invoice processing (write authorization):

Depending on sum in each currency

The system does not convert, but rather the authorization relates to the sum and the currency. It is thus necessary to make authorizations for a particular maximum sum dependent on the currency, and also no problems arise if the exchange rates are not properly maintained.

Writing the account-assignment values in field 1 . . . n (separately, i.e., any employee can edit particular fields and can select only particular values therein)

Previous business event (cancellation, dunning letter, invoice)

Invoice receiver

A user can have different authorizations in different organizational units. These can be maintained entirely separately.

Maintenance of master data

Communication data

Bank details

Methods of payment

User management

Organizational unit

The following roles can be integrated in the eCSP (based on regulated workflow):

Auditor—this person's authorizations respectively for the invoices assigned to him:

System transactions: display invoice details, PDF, process, approve, reject invoice

All invoice details (read)

Account-assignment fields (all, write)

Internal notes (write)

Queries to RS (write)

Next operative (read only)

Releaser

System transactions: display invoice details, PDF, process, release, reject invoice

All invoice details (read)

Account-assignment fields (all, read)

Internal notes (write)

Dispatcher

System transactions: display invoice overview, invoice details, PDF, assign employees

All invoice details (read)

Account-assignment fields (all, read)

Internal notes (write)

Queries to RS (write)

Escalation manager: not an explicit role, can be anybody. The only explicit task is to receive messages if an invoice is being processed too slowly.

Accountant

Download the batch input sessions

Finance Director

System transactions: display invoice overview, invoice details, PDF, process, release, reject invoice, assign employees

All invoice details (read)

Account-assignment fields (all, write)

Internal notes (write)

System Administrator

Manage users

Manage authorization profiles

Assign authorization profiles, authorizations

Choose preferred file format

Accounting service provider

Workflow settings

Account-assignment fields

Account-assignment values

Authorization management for auditing

For printing the invoice displays described below, the standard print function in the respective Internet browser may be used.

The following illustrative type of invoice presentation is possible:

When logged onto the frontend, the user is provided with a tabular overview of all the invoices which he/she is permitted to view. Each invoice is represented by a row entry containing the following details:

Invoice issuer

Invoice number

Date of invoice issue/alternative due date (alternatives can be selected)

Invoice sum in invoice currency (the currency of each invoice can also be specified)

Status of the invoice (new, processing in progress, released, rejected, query, response given)

Check user (current operative) displays

The invoice overview can be sorted upward and downward by all columns (invoice issuer, sum, currency, status, date).

The invoice overview can be reduced by means of flexible selection. A selection can be made both for individual values and for intervals for all the aforementioned fields. The chosen sorting and selection criteria need to be able to be stored on a user-specific basis.

The invoice overview can be downloaded from the frontend in CSV format and as an Excel file.

For each invoice, the invoice details can be displayed using drilldown. The advertisement template chosen by the invoice issuer is displayed in the Internet browser (e.g. in the form of HTML), and can also contain the invoice issuer's logo, for example. This display shows the invoice receiver all the relevant details of the invoice (for example single items on the invoice).

To view the printed version of the invoice, the user can additionally display any invoice as a PDF file. In this case, a second browser opens and shows the user the invoice which he could have been sent by mail. The PDF file is downloaded and displayed using the appropriate program (e.g., Adobe).

Each organizational unit can provide any number of further data fields (e.g. account-assignment fields). When the system is set up, the organizational unit stipulates the following once per account-assignment field:

Name of the field (e.g. cost center, general ledger account, etc.)

Permissible values for each account-assignment field

In addition, an n-stage hierarchy (of account-assignment values) can be created for each account-assignment field. Hence, first, simple assignment of permitted account-assignment values (e.g., cost centers) to employees is made possible, which means that, by way of example, an employee with authorization for a super ordinate cost center can also post to all subordinate cost centers. Second, it is possible to make evaluations on these hierarchical levels (e.g. on cost centers or node cost centers). It is possible to post to leaves. Not all leaves have the same depth. The values permissible for a field can be entered manually or else can be delivered automatically, for example via an interface, in a prescribed format and can be received in the eCSP. It is possible to stipulate whether each account-assignment field is filled manually or automatically.

Account assignments can be made either at invoice level or at invoice-item level. To permit automatic account assignment for invoices, an organizational unit can store invoice types (at header level) and invoice-item types (at item level) for each invoice issuer and can define default account-assignment values therefore which the system enters automatically upon the arrival of appropriate invoices or invoice items.

The invoice receiver can stipulate in advance whether or not fields which are filled with default values can be edited and whether or not they are displayed, and whether or not they need to be filled in. This means that an invoice can be disabled for release until the cost center is available, for example.

A workflow strategy stipulates whether a workflow proceeds “on a regulated basis” or “individually.” When a workflow is regulated, there is a precise stipulation of how many approval steps need to be performed by which possible users before an invoice can be released. With an individual workflow, the invoice is delivered to a standard initial operative or dispatcher, who then stipulates the first operative (or approver). Each operative performs his part of the auditing and forwards the invoice to the next operative. This continues until the invoice ends up at a releaser and the releaser releases the invoice.

A workflow strategy may correspond either to the individual workflow or else to a regulated workflow with a particular number of approval steps and rules (for example parallel or sequential checking).

It is possible to create further strategies with users.

The workflow can be set up by a user or an organization itself, advantageously online.

For each invoice, it is possible to implement the processing options below (irrespective of whether or not a workflow is now used). An invoice continues to be processed until it is rejected or released.

For every invoice item, a note can be recorded in a text field (arbitrary text comments). Any user having authorization to process invoices can be authorized to do this. This serves the purpose of internal processing of the invoice and can be viewed only by users associated with the invoice receiver, but not by the invoice receiver or the operator's support employees. The recording of such an “internal” note does not change the status of the invoice.

For an invoice, a user associated with the invoice receiver can record a query for the invoice issuer. The result of this is that the status of the invoice changes to “query” on both sides (RE and RS). The workflow pauses until a response is given. During this time, the invoice continues to be available in the invoice overview.

An invoice receiver can reject an invoice by interacting with the eCSP (pressing a button). During this process, the RE can be presented with n different structured reasons from which he can select one or more. These n reasons can be predefined by the RE. In addition, he can record an arbitrary text comment visible to the RS in the query field. If an invoice is rejected, there is a change of status to “rejected” on both sides (RE and RS). The invoice is transferred to the RE's backend with an original record and also a cancellation record. The RS can cancel the invoice as a result of the message on his backend.

All previously defined, visible further data fields (account-assignment fields) can be filled in either at header or item level. In the case of hierarchically structured account-assignment fields, input help is provided in the tree structure.

To this end, the eCSP prescribes a selection. For this, the eCSP needs to decide whether account assignment is to take place at invoice or invoice-item level. Depending on whether the default values differ from one another at invoice-item level, the eCSP stipulates the level for default account assignment and fills all the account-assignment fields with the proposed values. Both the level of account assignment and the values in the account-assignment fields can be altered by the user—provided that this is permitted by the chosen field control. In which steps and by which operatives this is done depends on whether or not the invoice receiver uses a workflow. Accordingly, one of the two processes specified below is used for auditing.

It is also possible to enter a plurality of account-assignment values for each account-assignment field. In this case, the sum can be split either absolutely or as a percentage. In the course of the approval and release process, payment conditions can be specified. Normally, the payment condition is already part of the signed electronic invoice. Once this field has been filled, it cannot be altered. If it has not been filled, however, then the system fills it in the machine-readable invoice version (XML) using the value which has been preset in the appropriate supplier. If this value is not the desired value or if the field is still empty, then it can be filled in manually.

A user authorized to do this can save an invoice including the changed data, recorded account assignments etc. and thus approves the invoice. The approval status is updated separately from the invoice status (as before “processing in progress”).

An invoice can be forwarded with maintenance of status from one operative to another operative. In an appropriate field, the operative selects the name of the user who has approval or release authority.

If an invoice is processed beyond a predefinable period of time, notifications can be sent to the escalation manager. The escalation manager can assign a new operative to the invoice.

Invoice release means that an invoice can be paid. This assumes that auditing has been completed successfully and that a posting record is being or has been created for this invoice.

In the individual workflow, release is also possible, in particular, when approval has not yet taken place. In the regulated workflow, release is possible only if the previously stipulated workflow steps have been performed.

In principle, an invoice can be released from any status. If a rejected invoice is released, a new original record can be created or the cancellation record can be revoked.

An RE can define for each RS a maximum sum up to which invoices are automatically released by the eCSP (system). For these rules, validity periods can be stipulated. In order to ensure that record creation does not proceed incorrectly, the system should be configured for this case sufficiently for all the necessary account-assignment fields to be filled with proposed values.

If the RE wishes to pay an invoice from his own financial software system (payment order placed), then an interface can be used to send a corresponding status update message to the eCSP. The eCSP can receive this message. The RS is thus informed about initiation of the payment, and the status of the invoice is set to “settled” on the web. This status update can also be deactivated by the RE, however.

Every organizational unit can use a workflow for auditing. If it does not use it, then the invoices are processed using the quite normal invoice display (invoice overview) in the frontend.

If an organizational unit processes its invoices with workflow support, then the invoice overview is used only by dispatchers or super ordinate entities (for monitoring purposes). The operatives from financial accounting and logistics are provided with access to an invoice which is to be checked by means of their e-mail inbox. For every invoice, they receive an e-mail with an appropriate link.

The eCSP can be configured such that the link alone does not actually authenticate the user; he then still needs to enter his personal password. The operative fills in the fields for which he is responsible and saves the data.

Either an order of particular operatives has been stipulated in advance (regulated workflow), in this case the operative has finished, or the operative needs to determine his successor himself (individual workflow), in this case he needs to select the appropriate name, and the system will likewise send this employee an e-mail with a link to this invoice. It is possible to select all users with appropriate authorization for approval or for release. As soon as an invoice has been released, the workflow stops.

Auditors in an organizational unit without workflow support enter the invoices overview and check the invoices from there. It is possible to perform the same functions as with a workflow (filling in account-assignment fields etc.), the checking employees are just not automatically coordinated by the system. If, by way of a non-limiting example, a medium-sized company has a total of just two auditors, then the device of the workflow is not absolutely worthwhile, since the employees can easily have a discussion with one another.

With any processing step, whether performed with or without a workflow, change records can be updated. Each change can be provided with a note of the day, the time, and user initials, and can be reproduced, specifying the system transaction, the change of status and the old and new values of the fields which have changed. This can affect any status-changing system transaction and any field which is relevant to a change record, i.e.:

Any account-assignment field

Internal notes

Queries

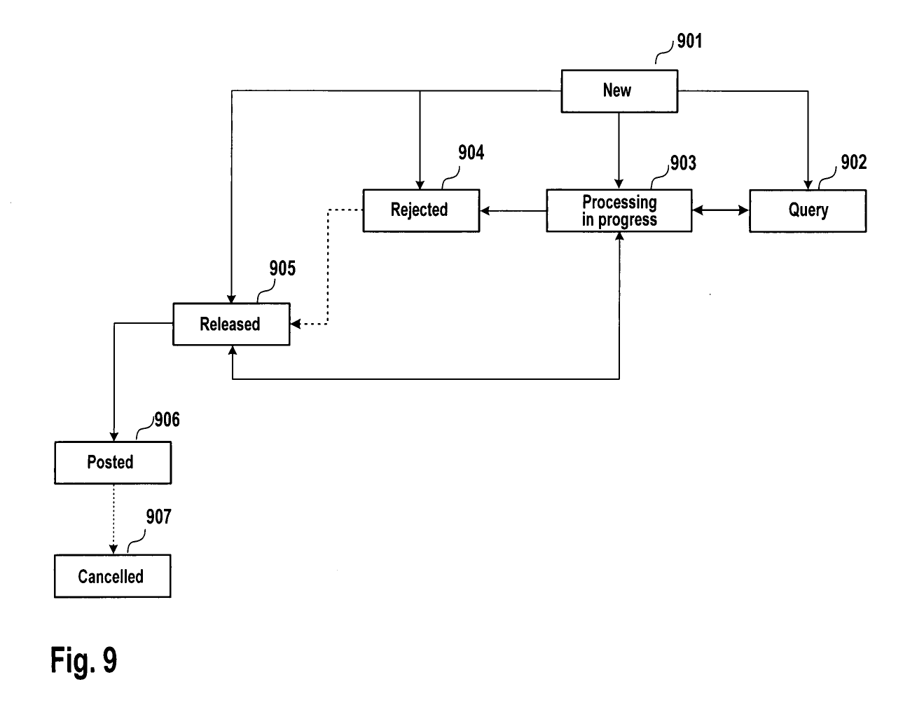

A newly delivered invoice which has not yet been considered has the status “new” with the invoice receiver. As soon as it has been considered by a user associated with the RE, it has the status “processing in progress”. Subsequently, the statuses shown in FIG. 9 and in the table below are possible, and their changes need to be specified as part of the design and checked precisely. Any status change on the side of the RE also results in a status change on the side of the RS, i.e., the eCSP can send respective corresponding status updates to the consolidator.

| | | Processing | | | | |
|---|---|---|---|---|---|---|
| | | in | | | | |
| From/to | New | progress | Query | Released | Posted | Rejected |
| New | — | X | X | X | — | X |
| Processing | — | — | X | X | | X |
| in | | | | | | |
| progress | | | | | | |
| Query | — | X | — | — | | — |
| Released | — | X | X | — | X | X |
| Posted | — | — | — | — | — | — |
| Rejected | — | X | — | X | | — |

From the invoice overview, from the display of invoice details, and from the processing (checking) of an invoice, it is possible to jump to the transaction history (change date, change time and user). The transaction history includes all actions performed, particularly actions in the approval process. Both initial entries and changes to account-assignment data can be logged together.

The invoices can be accepted, processed, or made available, inter alia, in the formats XML-Idoc (INVOICE01, INVOIC02) and UN/EDIFACT D96.A. The customer can stipulate which format he prefers in his master data.

The invoice receiver can use the eCSP to receive frontend (Internet browser) files by means of HTTPS from the eCSP operator. He authenticates himself on the eCSP and downloads the invoices as XML-Idoc files using https to a directory of his choice. Upon receipt, he can select from the shipments which are available.

The eCSP provides the invoices as a file in the formats specified above within the eCSP operator's firewall. Conventional download procedures and https can be used to transfer these files to other systems. A downloaded invoice needs to be provided with an identifier so that it is not loaded into the customer's backend system a second time.

The eCSP can automatically create accounting records using the invoice information and the account assignment which has been performed. The system matches the fields against the XML-Idoc invoice automatically. These are put into a batch input session.

Batch input sessions which have already been created can be downloaded to a separate system, which can also be the other side of the operator's firewall, using https. From that system, they can be uploaded to the respective financial accounting system again and processed there. The format of the batch input sessions can be prescribed. Processed sessions are identified as appropriate in order to prevent repeated processing.

It is possible to provide automatic assurance that an accounting record is not created twice for the same invoice.

While an invoice has been released but an accounting record has not yet been created, processing can be started by the releaser again and then the account assignment can be changed.

It is possible to prevent the frontend from being used to cancel an invoice for which an accounting record has already been produced. If an invoice is cancelled in the backend, the status can be matched as appropriate in the frontend by employees who are authorized to do so. On the basis of the stored cost events, the transactions, posting operations or release operations etc. which have been performed can be counted in the selected period.

With this report, the counted cost events can be transferred to a charging service.

Following transfer, the processed cost events can be deleted.

An invoice receiver can set which events he would like to be notified of in the form of an SMS, an e-mail,or a letter, and which employee is to receive this message. A plurality of employees can also receive different kinds of notifications about the same event. These events can include one or more of the following:

Invoice receiver has been cleared on a Biller Consolidator network

Invoice issuer has accepted or rejected registration of the customer

Invoice issuer has left Biller Consolidator network

New invoice has arrived

Discount warning (x (settable) days before expiry of the discount period, x can be set on an RE-specific basis)

Invoice is due (x days before due date, x can be set on an RE-specific basis)

Response from the invoice issuer (to a query)

Invoice issuer revokes invoice (e.g. because there was an error)

Notifications by e-mail can contain a link to an appropriate web page.

An invoice issuer can maintain his master data held in the eCSP himself, i.e., according to the respective user's authorization it is possible to change the postal address and other communication channels, and bank details, online.

The eCSP can be integrated in a portal.

One of the services which the eCSP operator can provide for the connected invoice receivers is archiving of all invoices. Archiving removes particular invoices from the online stock and instead makes them available to the RS in an valuable form on a data storage medium which cannot be overwritten. Not being able to be overwritten is of particular advantage for this solution's VAT compliance. With each archiving pass, the data stock can be selected as follows:

All invoices

From precisely one particular organizational unit

With delivery date available (day's date minus RE-specific deadline, stipulated in customizing)

Rejected, cancelled, or posted with status

For each invoice which is to be archived, the following information can be archived:

Original invoice digitally signed (electronic format such as IDOC or UN/EDIFACT or XML etc.).

Associated invoice in readable format digitally signed (PDF—can also be original invoice in the Thin Consolidation case).

Supplementary document from workflow with signatures and comments from the approvers, releasers, etc.

Update of the business event: the log for all write actions, including queries and notes, needs to be archived at the same time.

The RE can individually set delivery cycles in line with which it is provided with archive data.

It is possible to integrate signature checking tools which can also be contained on the non-overwritable data storage medium.

The archiving software can provide search criteria (e.g., invoice date, customer, sum, currency, invoice number, status) permitting invoices to be found quickly. The search results can be sorted according to various criteria. The archiving function provides the operator with a function which he can use to print all invoices for a particular invoice receiver as a collective invoice on paper in order for this collective invoice to be made available to the invoice receiver for tax purposes.

For invoice processing by the customer, all the process steps with the associated objects can be logged, so that the process sequence remains reconstructable (among other things, the invoice, approval, release, rejection, forwarding, account assignment, notes, fetching of record data). Logging can take place with identification of the operative, a time stamp, an invoice reference, and an action which has been performed.

The data on the eCSP can be archived by the eCSP operator using a standard archive interface (archive link). It is possible to load the data back into the system (e.g. for evaluation purposes).

A support employee can observe all the messages and processes relating to an invoice or relating to an organizational unit on a monitor. If problems should occur, for example an invoice has not arrived correctly, it is possible to use the messages to comprehend the point at which the problem has occurred. Support employees for the eCSP operator should be able to see the same screens as their customers whom they are intended to help. Provision can be made for a particular user's initial image to be entered on a particular organizational unit's invoice overview. Provision can also be made for the support employee to be intermittently able to reflect a user's properties onto himself in order to be able to comprehend the problem which his counterpart currently has. If an invoice issuer logs off from the network, the status can be updated in the biller list, the connected REs can be informed and subsequently no invoices from this RS can be accepted anymore.

It is also advantageous if one RE cannot see any invoices for another RE. Provision can also be made for a support employee never to be able to enter into the action (rejecting invoices, account assignment etc.) “unnoticed,” i.e., without corresponding logging by the system.

Processors suitable for the execution of a computer program for performing the above methods include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices (storage means) for storing data, e.g., magnetic, magneto-optical disks, or optical disks. Information carriers suitable for embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the invention can be implemented on a computer system having a display device such as a CRT (cathode ray tube) or LCD (liquid crystal display) monitor for displaying information to the user and a keyboard and a pointing device such as a mouse or a trackball by which the user can provide input to the computer. Other kinds of devices can be used to provide for interaction with a user as well; for example, feedback provided to the user can be any form of sensory feedback, such as visual feedback, auditory feedback, or haptic feedback; and input from the user can be received in any form, including acoustic, speech, or haptic input.

The invention is now described in more detail by way of reference to the drawings.

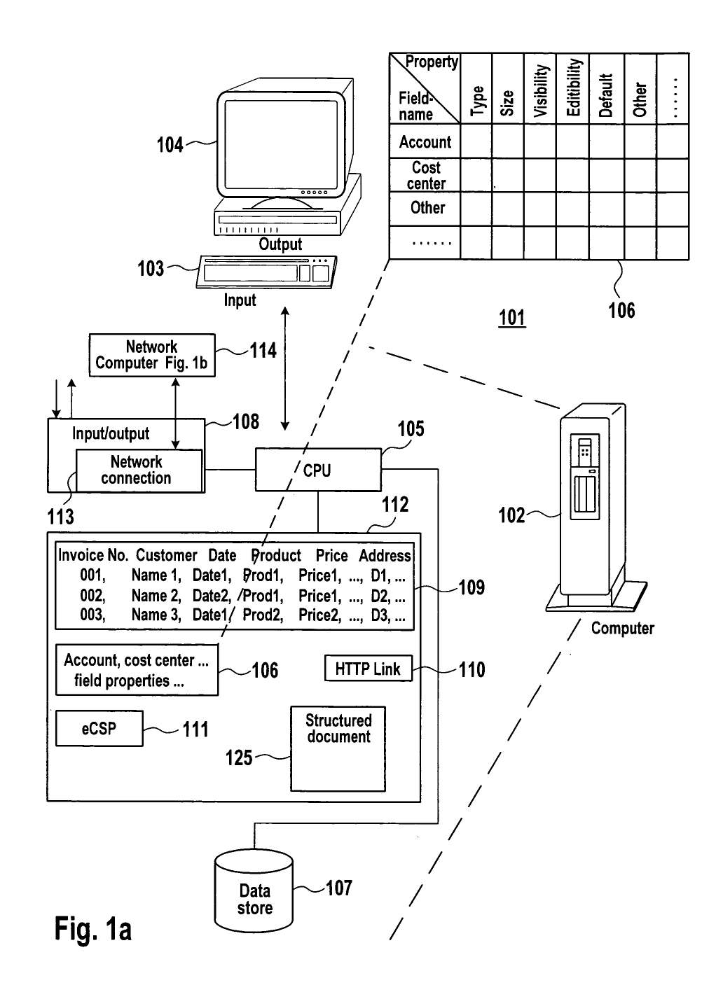

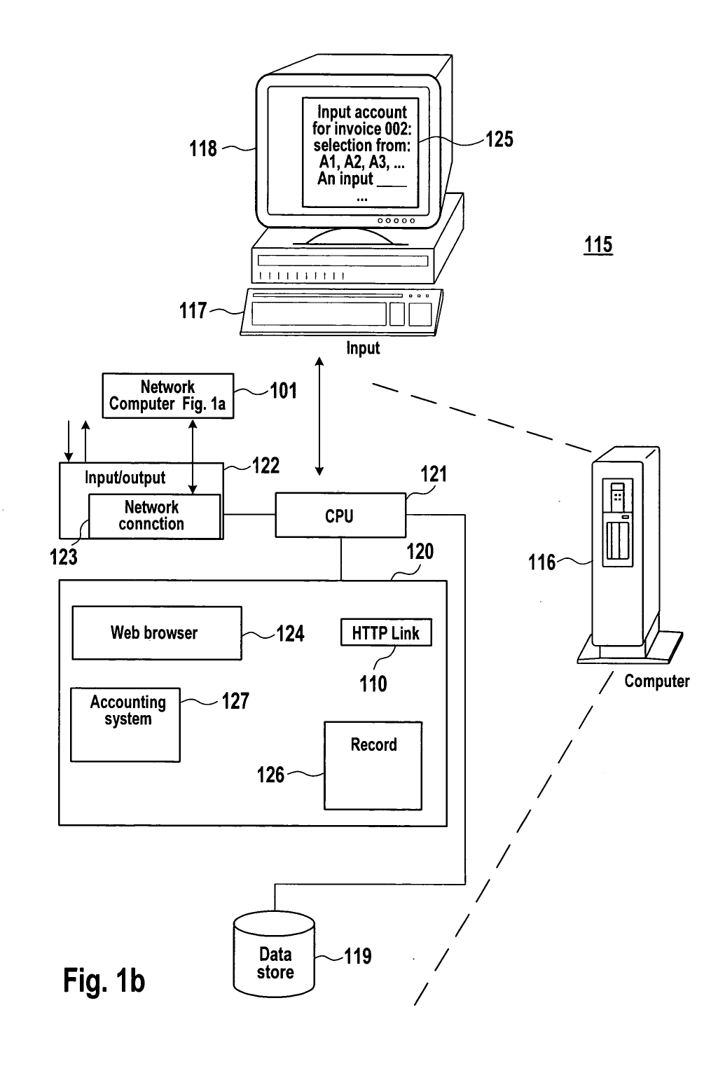

FIGS. 1a and 1b show an example of one implementation of an embodiment of the invention: a computer system 101 which can be connected to a computer system 115, both of these systems being provided with programs or program modules for carrying out the disclosed method(s). FIG. 1a shows a computer system 101 having a computer 102 with a CPU 105 and a main memory 112 storing software applications for execution by the CPU 105. Such a software application is program 111, the eCSP. The computer system 101 also comprises input means 103 and output means 104 for operation by a user, for example for the purpose of starting programs and/or for inputting and outputting data. The computer system 101 also has general input and output means 108, including a network connection 113, for sending and/or receiving data and documents, for example via a network connection to one or more further computer systems 114, and for receiving electronic invoices. A multiplicity of computer systems similar to the computer system 101, particularly a computer system 115 in FIG. 1b, can be connected to one another in the form of a network by means of the network connection 113. In such a case, the network computers 114 can be used as further input and output means or as further storage means. In order to store data, the computer system 101 has a nonvolatile storage means 107. FIG. 1b shows the computer system 115, which can be connected to the computer system 101 from FIG. 1a. The computer system 115 comprises a computer 116 with a CPU 121 and a main memory 120 storing software applications for execution by the CPU 121, and general input and output means 122 including a network connection 123 for sending and/or receiving data and for setting up a network with other computer systems, particularly with the computer system 101 from FIG. 1a. The computer system 115 also comprises input means 117 and output means 118 for operation by a user, e.g. for the purpose of starting programs and/or for inputting and/or outputting data. In addition, a nonvolatile memory 119 is provided.

In the exemplary embodiment in FIGS. 1a and 1b, the eCSP 111 may be installed on the computer system 101, which can be attributed to a first party. The eCSP 111 may allow a second party to use the computer system 115 to process electronic documents, invoices in the example, on the computer system 101, provided that the two computer systems are connected to one another. This will be explained in more detail below.

A first assumption is that the first party has an invoice available in electronic form on the computer system 101. The reason for this may be, by way of a non-limiting example, that an invoice issuer associated with the first party has loaded an electronic invoice into the computer system 101 via the input 108 by means of e-mail or data storage medium or via a network connection. The eCSP 111 is executed on the computer system 101 and receives electronic bills via input/output means 108. These bills may be provided to the eCSP by billers who want to make their bills available to their customers (the second party) by an independent service provider (the first party), who uses the eCSP. The eCSP 111 may store the incoming bills automatically in memory 112 (and/or storage means 107) in the form of one or more lines of one or more tables. In the example three bills are stored as three lines in table 109. Table 109 comprises a plurality of columns, e.g. invoice number, name of the customer, a date, products, price, address and others. An invoice received in this manner may also be converted into an internal format and then stored in a table like table 109. Table 109 contains a multiplicity of columns containing invoice information such as invoice number, customer, date, product, price, address etc. The rows in the table 109 comprise data fields corresponding to the columns and form the individual invoices. The invoices can naturally also be split over a plurality of tables (relational database). As soon as a new invoice is stored in such a table 109, or after a presentable number of new stored invoices, the eCSP 111 generates a structured document 125, e.g. an Internet page, from one or more data fields of an invoice from the table 109 with the addition of further data fields from a table 106. The structured document 125 can contain data, tags, or program code. This structured document 125 can be displayed in a web browser 124, and the further data fields can be selected and/or edited using the web browser 124. The structured document 125 is preferably a structured table or an XML file or an HTML file or a Java Server Page. The name and properties of the further data fields are stored in a table 106. The names can be oriented to the purpose of the further data field or the type of data or information to be input, e.g. account, cost center etc. The properties defined can be variables such as types, size, visibility, editability, a default value etc. A type can be, by way of example, its number or character string, the size corresponds to the length of the field, visibility indicates whether the field in question is displayed in the browser or remains invisible, editability indicates whether the field can be edited in the browser. The default value property indicates whether a value and which value is written to the field in question beforehand by the eCSP. Additionally, predefinable rules may be applied to the further data fields. E.g., it's a further data field as the properties invisible, editing mandatory, then a default value has to be entered. When the system is set up, the structured document 125 and the table 106 can be designed specifically for each invoice issuer or for each first or second party or for a particular operative associated with one of the parties. The eCSP 111 also generates an HTTP link 110 which points to the structured document 125. The HTTP link is sent to the second party by e-mail or SMS. The address of the second party may either be contained in a specific data field of the electronic invoice or stored in the system during customizing the eCSP. The second party or one of its operatives can receive the HTTP link 110 with the computer system 115 via the input 122. The second party can use the web browser 124 to execute the HTTP link 110, and the web browser 124 then uses a network connection 123, preferably with an intermediate logon step, to access the structured document 125 which is on the first party's computer system 101, to open it and to display it on a screen 118 in the computer system 115. The second party's operative sees a display produced for him and can select and/or edit the further data fields provided for processing. The structured document (or Internet page) 125 may contain all or part of the information contained in the electronic invoice as received by eCSP 111 and all or part of the further data fields 106 for editing. These details may be defined during the customization of the eCSP. In the example, an account number has to be selected from a list and entered into the input field of the Internet page 125. After entering the data, the Web browser 124 sends the data via the net connection to the eCSP 111, and eCSP 111 may add the further data fields to the electronic invoice 109. This process may be repeated at predefinable number of times with a predefinable number of users (the case workers) of the computer system of the customer until all of the further data fields 106 are edited and until the electronic invoice is accepted by the customer. In order to define an electronic invoice as accepted, a still further data field may be added, which may only be edited by an authorized user of the customer. The exact sequence of such a process (workflow) may be defined during customization of the eCSP. If the invoice is finally accepted, the eCSP creates an accounting voucher 126 from the invoice and sends it to the customer.

Following data input, the operative can close the structured document 125. The eCSP 111 monitors the status of the structured document 125. When the status “processing terminated” has been identified, the changed or edited structured document 125 can be sent to the second party as an accounting record (record) for input into the second party's electronic accounting system. Prior to that, the record can still be reformatted in order to align it with the formats used by the second party. Alternatively, a further structured document 125 produced specifically for another operative and also a corresponding further HTTP link 110 can be generated from the changed structured document 125 or from the invoice with the addition of further data fields and/or with the omission of data fields. Accordingly, the further HTTP link 110 can then be sent to the other operative, whereupon this operative can perform the rest of the processing of the invoice or of the further structured document 125 in a similar manner. In parallel or simultaneously, it is also possible to produce two different structured documents 125, designed specifically for different operatives, and corresponding HTTP links 110. This would allow the invoice to be processed in parallel or simultaneously in a similar manner. When the system is set up, one or more different sequences of such configurable work steps can be preset as a workflow.

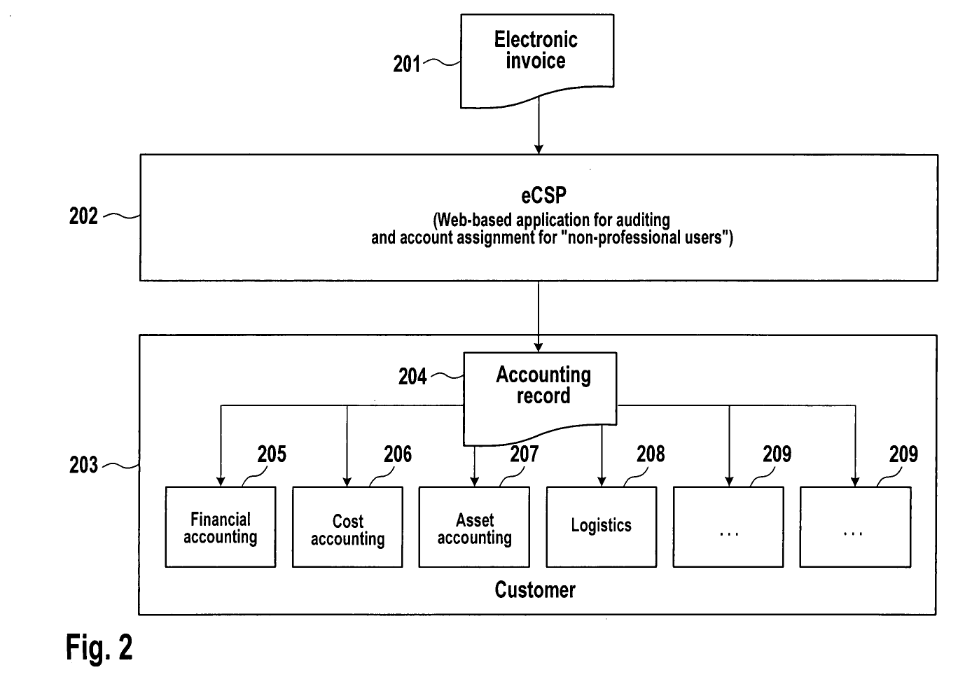

FIG. 2 shows an example of a path on which an electronic invoice can reach an electronic accounting system associated with an invoice receiver (customer): An electronic invoice 201 is sent to an eCSP 202. The electronic invoice 201 is, as explained with reference to FIG. 1 above, assigned to an account and checked using the eCSP installed on the computer system. The eCSP produces an accounting record 204 from the changed structured document and may send it automatically or upon request to a piece of accounting software 203 belonging to the invoice receiver, the accounting software likewise being installed on a computer system. The accounting software 203 can then assign information from the record 204 to its individual modules, for example to financial accounting 205, to a cost accounting module 206, to asset accounting 207, to a logistics module 208 etc.

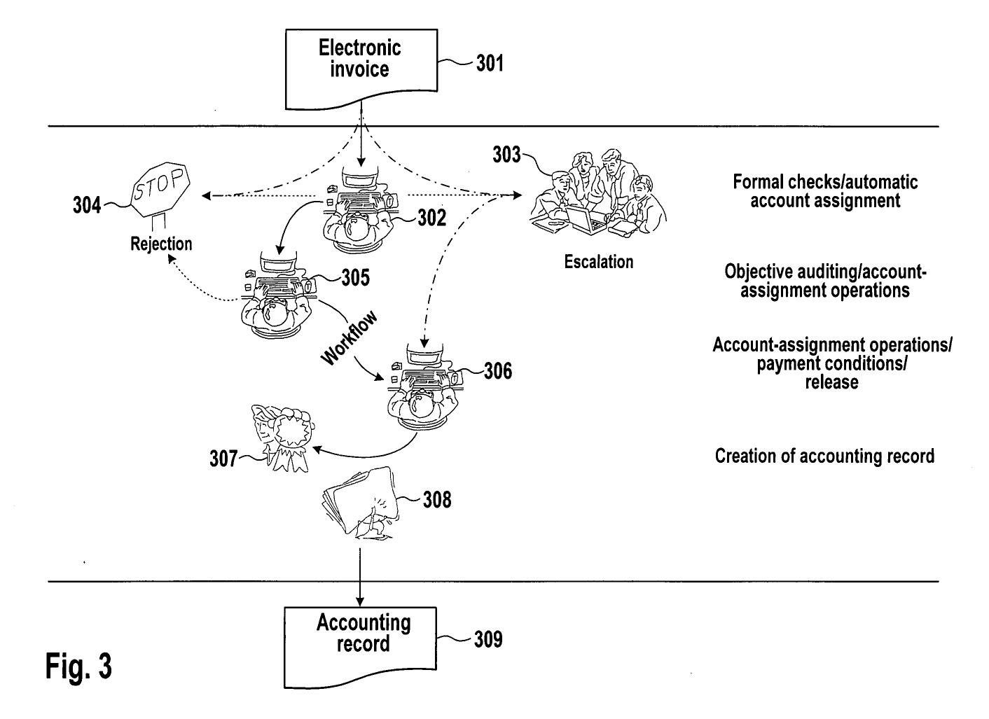

FIG. 3 shows, by way of example, possible work steps which can be performed using an exemplary implementation of the inventive eCSP. When an electronic invoice 301 is sent to an eCSP in accordance with the invention, the electronic invoice 301 can be automatically checked according to presetable criteria in a first step 302. Depending on the type of error and on the criterion prescribed in this regard, a formal check (escalation) can be performed in a step 303. To this end, the eCSP may produce a corresponding structured document and send an e-mail with an HTTP link to an operative who is available for the purpose (this procedure is what is meant when subsequently referring to the invoice being automatically sent or made accessible to an operative for processing). Alternatively, the electronic invoice 301 can also be automatically rejected in a step 304. To this end, a presetable e-mail can be sent to the invoice issuer. If the automatic check in step 302 does not return any errors, a workflow can be initiated. A corresponding structured document may be then produced in the manner already described and may be made accessible to an operative who then performs an objective check on the invoice in a step 305. He can then record the result of the check (for example objectively in order or not in order) in a further data field provided for the purpose. Once this processing has ended, the structured document is closed and, depending on the result of the check, the eCSP can automatically reject the invoice or can automatically make it accessible to a further operative for processing in the manner already described. The further operative can then fill in the fields with which he is provided, such as account number or cost center, in a step 306, i.e. can assign the invoice to an account. The invoice is then automatically made accessible to a further operative, who can then release or reject the invoice in a step 307. If he releases it, the eCSP may automatically produce an accounting record 309 in a step 308.

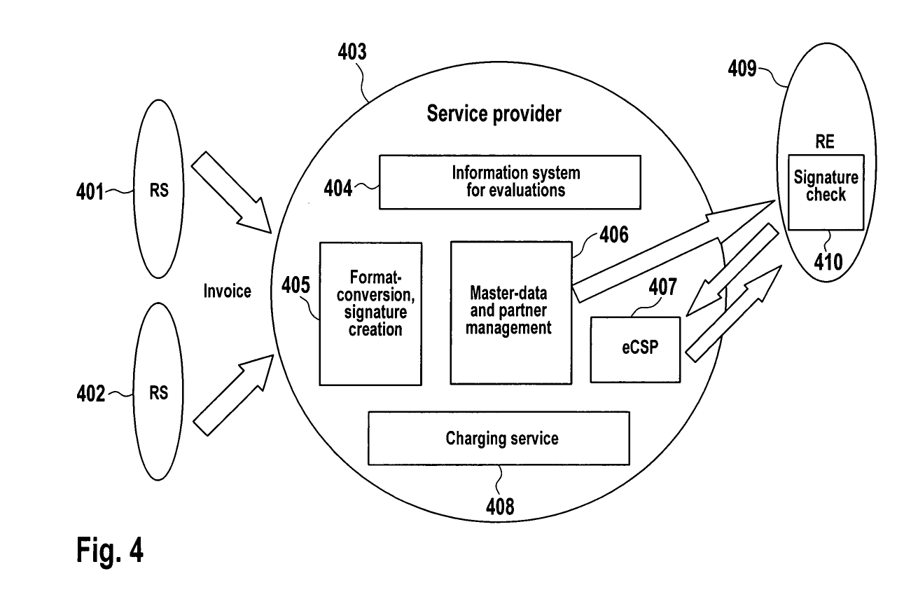

FIG. 4 shows an example of one possible arrangement and composition of systems which can be used to receive an invoice, to assign it to an account and check it electronically using an exemplary implementation of the inventive eCSP. A service provider 403 operates a computer system having an inventive eCSP 407, a piece of software 404 for evaluation purposes, a piece of software 405 for format conversion and creation of a digital signature, a piece of software 406 for managing master and partner data, and a piece of charging software 408. The computer system associated with the service provider 403 can be connected to computer systems associated with different invoice issuers 401, 402 and with an invoice receiver 409 via a network. An invoice can be processed using such an arrangement in the following manner: an invoice issuer 401, 402 sends an electronic invoice to the service provider 403. In the service provider's computer system, the software 405 may first perform format conversion. In addition, the electronic invoice may be automatically signed digitally. The invoice issuer should first have authorized the service provider to do this. The signed invoice is then first sent to the invoice receiver 409 for the purpose of checking the signature. To this end, the software 406 can provide appropriate address data. This is particularly advantageous because the signature needs to be created and checked by different legal persons if the invoice is to satisfy the legal provisions regarding VAT. When the signature has been checked, the invoice receiver 409 returns the invoice to the service provider. The eCSP then provides the service provider with it for the purpose of further checking and account assignment. The charging software 408 can be used to count the number of processed invoices or else individual response steps and to charge them to the invoice issuers and/or invoice receivers.

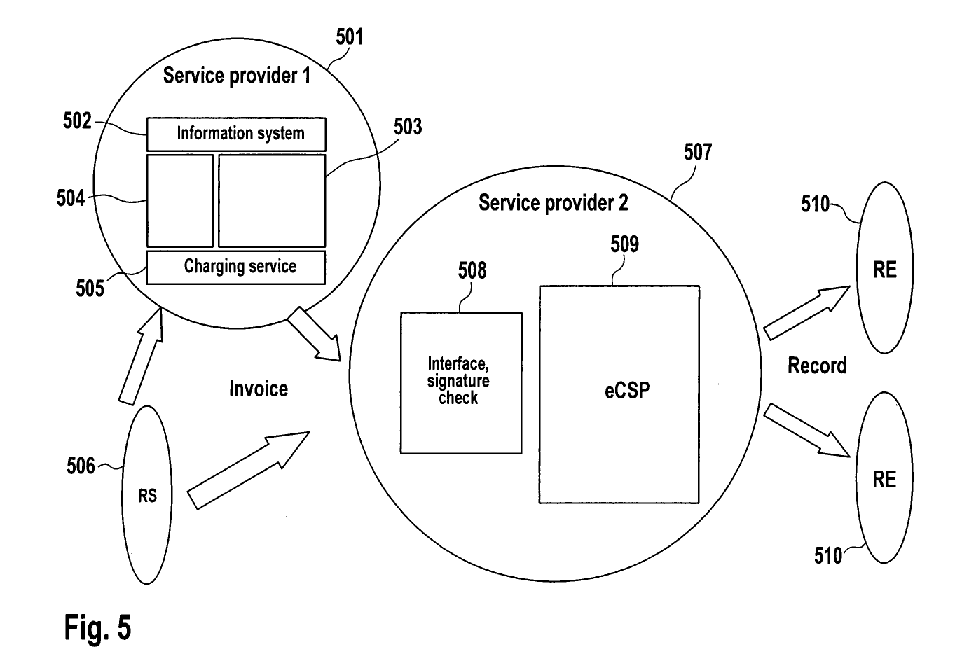

FIG. 5 shows another example of such an arrangement and composition of systems. In this example, a first service provider 501 with a computer system operates a piece of software 502 for evaluation purposes, a piece of software 503 for managing master and partner data, a piece of software 504 for format conversion and signature creation, and a piece of charging software 505. A second service provider 507 uses a computer system to run an inventive eCSP 509 and a piece of software 508 which is used as an interface and a signature check. There are also an invoice issuer 506 and various invoice receivers 510 with their own respective computer systems. In this example, the invoice issuer 506 can send an electronic invoice to the first service provider 501, can perform format conversion, and can digitally sign the invoice. The first service provider 501 forwards the invoice to the second service provider 507. To this end, address data can be provided by the management software 503. Alternatively, the invoice issuer 506 can digitally sign the invoice himself and can send it in an appropriate format directly to the second service provider 507. The second service provider 507 receives the signed invoice via the interface software 508, performs a signature check, and forwards the invoice to the eCSP for further processing, i.e. the invoice is stored, for example as file or in a table, as already described further above. The eCSP monitors the corresponding table and starts a workflow for processing as soon as a new invoice has been stored. Following processing, a record is forwarded to the relevant invoice receiver 510.

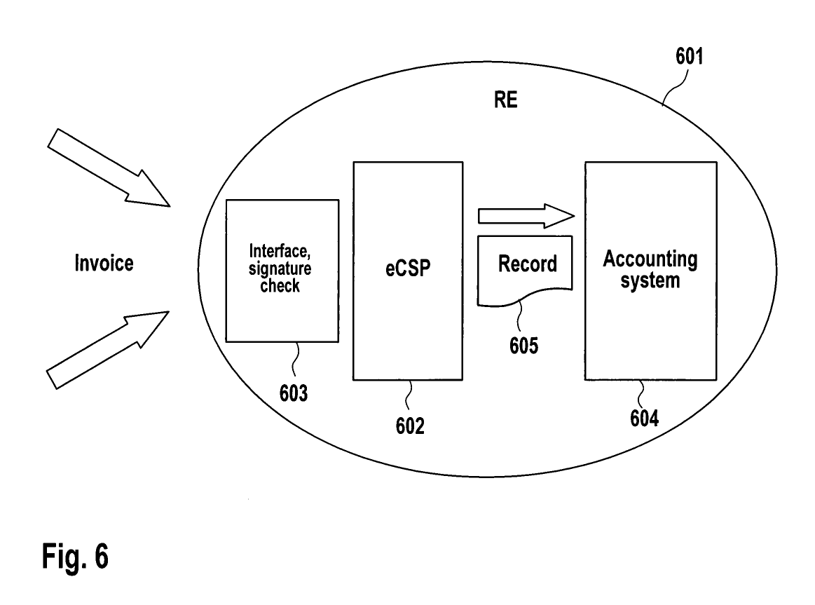

FIG. 6 shows another example of such an arrangement and composition of systems. In this example, the first and second parties are established within a company 601. The company 601 runs a computer system which can comprise an in-house network or an individual computer. The company 601 has an inventive eCSP 602, a piece of software 603 used as an interface and for signature checking, and an accounting system 604. An invoice is processed and assigned to an account in a similar way to that already described above. When an invoice has been released, a record 605 is produced by the eCSP and is transferred to the accounting system 604. Such an arrangement is advantageous when a company contains an accounting system but this accounting system does not have any eCSP functionality, and when a new functionality corresponding to the eCSP needs to be installed while retaining the existing accounting system.

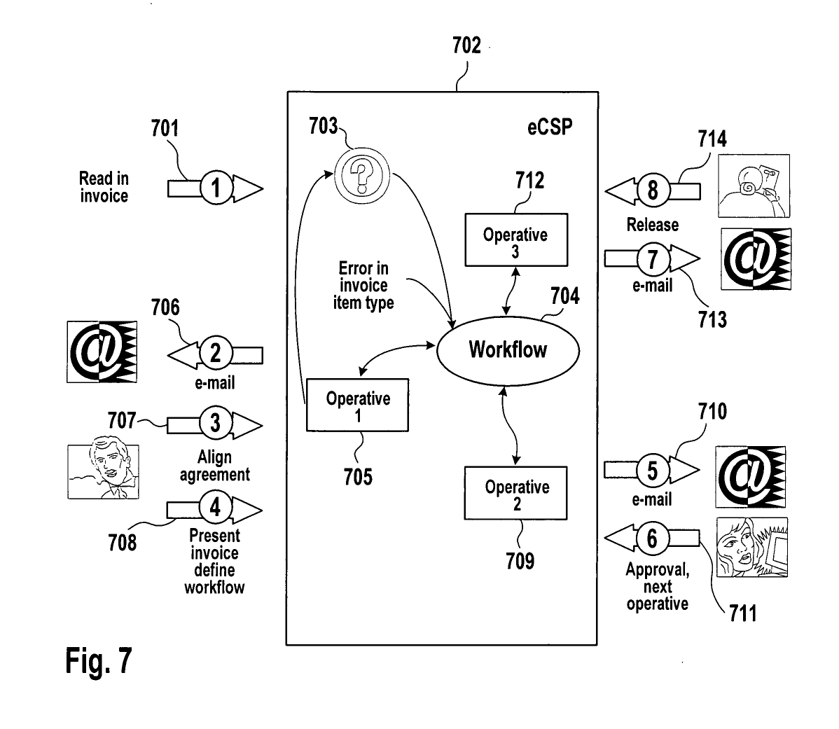

FIG. 7 shows an example of a “manual” workflow for processing an invoice in accordance with an exemplary implementation of the inventive method. The term “manual” means that the workflow can be changed by one of the operatives as it progresses. The numbers in the arrows indicate a sequence of certain steps. In a first step 701, an electronic invoice may be stored on a computer system as already described. In a first step 703, the eCSP 702 may automatically check the invoice on the basis of prescribed criteria. The check may reveal that the invoice item type is incorrect because, by way of a non-limiting example, a charge has been made for a service for which no charging was agreed between the invoice issuer and the invoice receiver, and therefore the charge was not stored in the system. The eCSP may then automatically start a manual workflow designed for this case and transfer the invoice to a first of the workers 705 by sending an e-mail to the operative 1 in a step 706. The operative 1 can then log onto the eCSP and, in a step 706, can align the settings with the eCSP, provided that it has been agreed with the invoice issuer that invoices with the invoice item type in question can be accepted. In a step 708, the operative 1 can stipulate a new or changed workflow and can input the invoice again. The eCSP then starts the automatic check in step 703 again. When the settings have been changed by the operative 1, no error is discovered, a corresponding workflow 704 may be called and the invoice may be transferred to an operative 2 in a step 709. To this end, e-mail is sent to the operative 2 in a step 710. This operative may log onto the eCSP 702, process the invoice (he approves it in the example), and close it in step 711. The invoice is then transferred to an operative 3 in a step 712. To this end, an e-mail is sent to the operative in a step 713. This operative logs onto the eCSP 702, processes the invoice (in the example, he assigns it to an account and releases it) and closes it in a step 714. This means that the invoice's processing has been changed and the eCSP 702 automatically produces a record for forwarding to the invoice receiver. FIG. 7 also shows this sequence of steps by means of the numbering of the arrows.

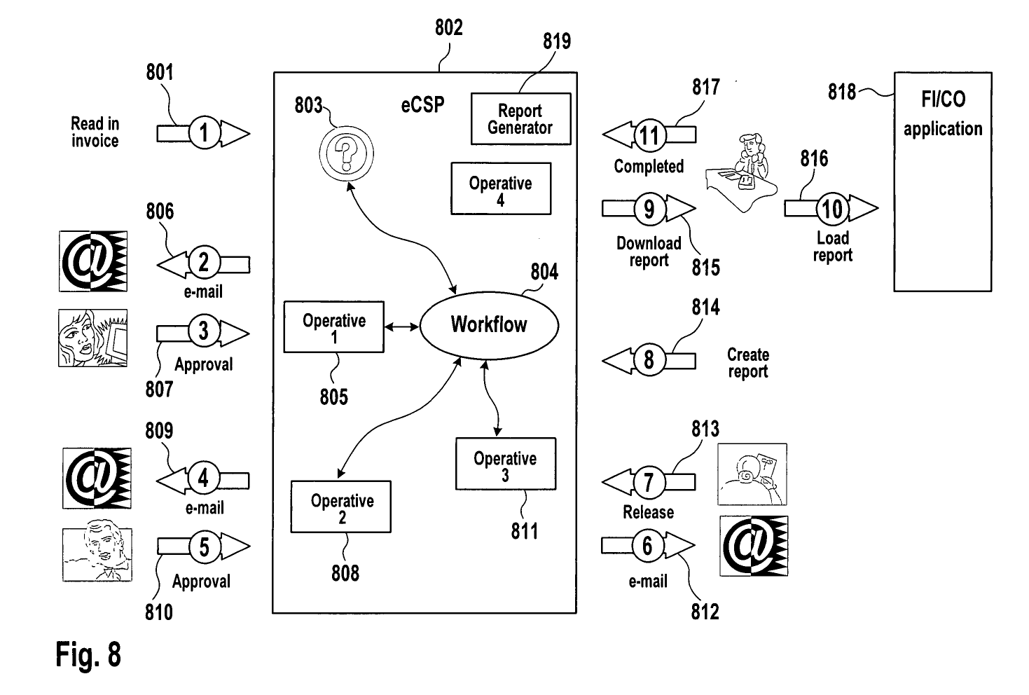

FIG. 8 shows an example of an “automatic” workflow for processing an invoice in accordance with an exemplary implementation of the inventive method. The numbers in the arrows indicate a sequence of certain steps. In a first step 801, an electronic invoice is stored on a computer system as already described. In a step 803, the eCSP 802 automatically checks the invoice on the basis of prescribed criteria. In this example, the check returns an error and hence a workflow 804 is started. In a step 805, the workflow transfers the invoice to an operative 1. To this end, an e-mail 806 with a link is sent to the operative 1. The operative assigns the invoice to an account and approves the invoice in a step 807. In a similar manner, there is then a check and subsequent approval by an operative 2 using the similar steps 808, 809, 810. Next, in a step 811, the invoice is sent to an operative 3 by means of e-mail 812 for release, which is performed in step 813. In a step 814, it is possible to initiate the creation of a report, i.e., evaluation of one or more invoices by a report generator 819. The report can be made accessible to an operative 4. To this end, an e-mail with a link is sent to the operative 4. The operative 4 can download the report file in a step 815 and can load it into a financial or controlling application in a step 816. In a step 817, completion of this operation can be indicated.

FIG. 9 shows for illustration a block diagram of an example of possible states for an electronic invoice, which could have been subject of the preceding processes. The state of an electronic invoice may be entered in a state field. The figure shows possible contents of the state field, i.e. possible states 901 to 907 of the invoice. The arrows indicate the sequence, in which the various states can be assigned. Dashed lines indicate options. In the example, the first state of an invoice is “New” 901. Starting from that state, the state can be changed to “Query” 902, “Processing in progress” 903, “Rejected” 904 or “Released” 905, depending on workflow and circumstances. Starting from “Processing in progress” 903, the state can change to “Query” 902, “Rejected” 904 or “Released” 905. Starting from “Query” 902, the state can only be changed to “Processing in progress” 903. Starting from “Released” 905, the state can be changed to “Posted” 906 or “Processing in progress” 903. Starting from “Posted” 906, a change to a state “Cancelled” 907 is possible. The remaining possibilities turn out accordingly.

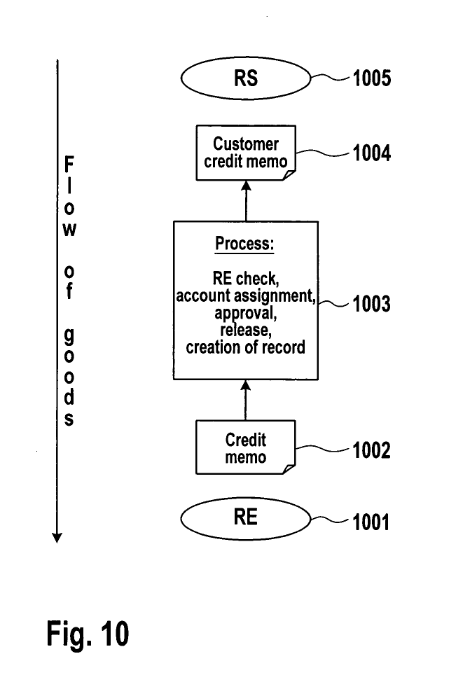

FIGS. 10 to 12 show further examples of applications of the inventive method.

In FIG. 10, an invoice issuer (RS) 1005 provides a service, e.g., delivers goods, to an invoice receiver (RE) 1001. To handle the remuneration, the payment, the RE 1001 can now send the RS 1005 a credit memo. This can be processed as an electronic credit memo 1002 using an eCSP 1003 in a similar manner to the method already described. The eCSP 1003 can be operated by the RS 1005 or by a third party authorized to do so. The eCSP 1003 can be used by the RS 1005 to perform the process steps of checking, account assignment, approval, release and record creation. The record created by the eCSP in the example is an electronic customer credit memo 1004 for further processing in the accounting system associated with the RS 1005.

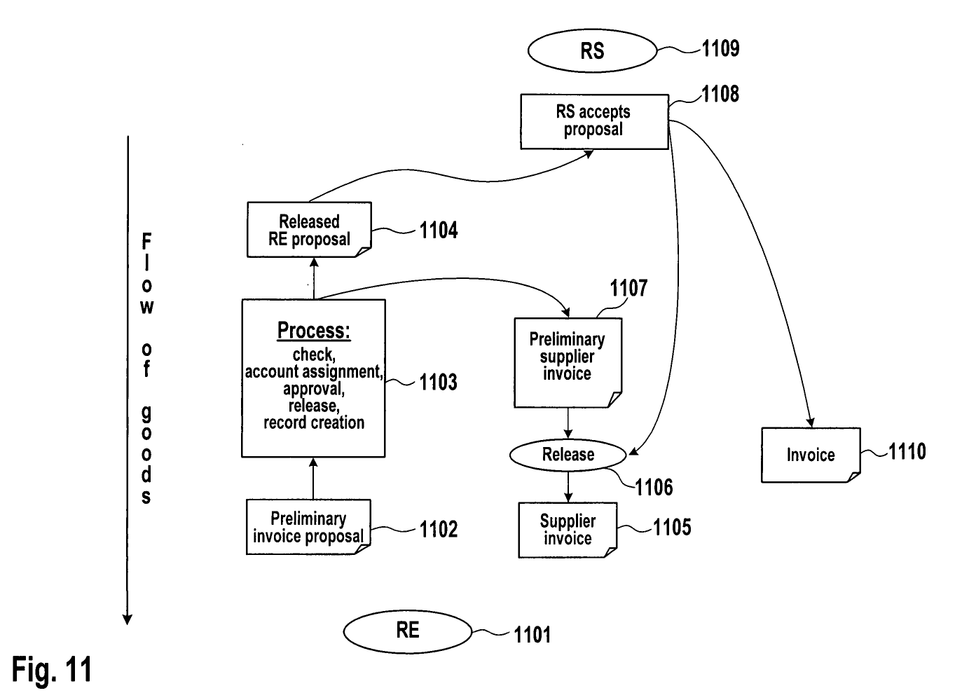

FIG. 11 describes a “self-billing” scenario. An invoice issuer (RS) 1109 provides a service, e.g. delivers goods, to an invoice receiver (RE) 1101. To handle the remuneration, the payment, the RE 1101 can now present the RS 1009 with an invoice proposal. This can be processed as an electronic invoice proposal 1102 using an eCSP 1103 in a similar manner to the method already described. The eCSP 1103 can be operated by the RE 1101 or by a third party authorized to do so. The eCSP 1103 can be used by the RS 1109 to perform the process steps of checking, account assignment, approval, release and record creation. The record produced by the eCSP in the example is a released invoice proposal 1104 and a preliminary supplier invoice 1107. The released invoice proposal 1104 can be accepted by the RS 1109 in a step 1108, and the RE 1101 is notified of this. The RS can additionally also create a VAT-related invoice 1110. The preliminary invoice 1107 can be released by the invoice issuer 1109 in a step 1106 and can be processed further in the accounting system associated with the RE 1101.

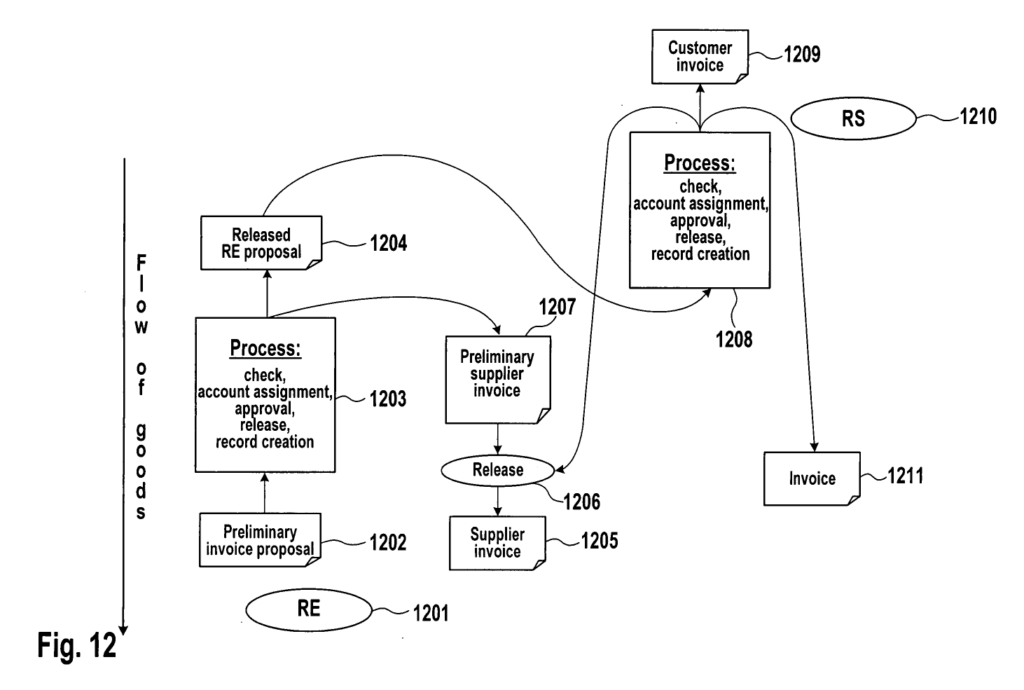

FIG. 12 describes a “self-billing” scenario from FIG. 2, which is extended by virtue of the released electronic invoice proposal 1204 being processed by the RS 1210 using a further eCSP 1208. The latter produces a customer invoice 1209 for further processing in an accounting system, a release message 1206 to the RE 1201 and, if required, a VAT-related invoice 1211. The rest of the reference numerals in FIGS. 11 and 12 correspond to one another.

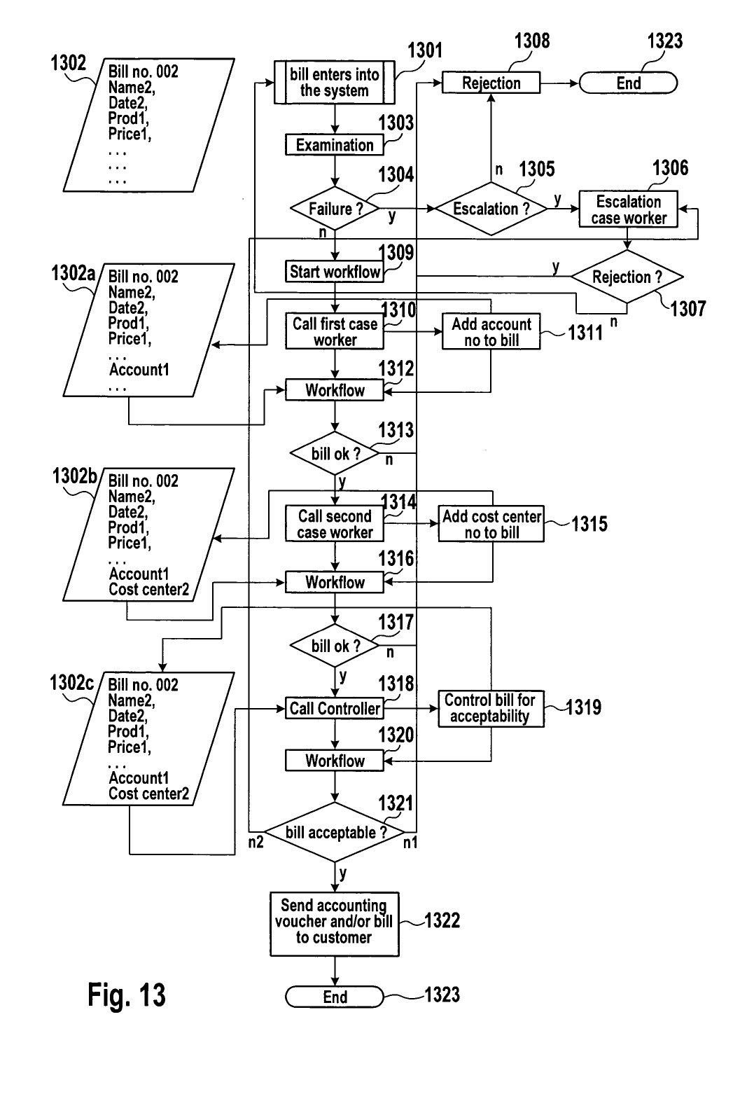

FIG. 13 shows an example of a process for processing an electronic document, e.g. an invoice, alternatively referred to as bill. The process starts at step 1301 when document is entered into the system. The eCSP performs an examination step 1303, in which the received document may be reviewed according to preset rules whether it fulfills predefined conditions. The eCSP also creates a structured document 1302 including all or part of the data fields of the incoming document and further data fields. If the examination reveals a failure an escalation may be initiated according to decision steps 1304 and 1305. In case no escalation procedure shall be initiated, which decision may be automatically performed by the eCSP according to predefined rules, the document is rejected in step 1308 by sending a corresponding email to the sender of the document. This may be performed automatically by the eCSP according to predefined emails, depending on the kind of the failure. In case an escalation procedure is initiated, an email comprising a link to a structured document 1302, which may be specifically designed for the escalation situation, is automatically send to an escalation case worker (ECW) in step 1306. The ECW may negotiate the case with the sender of the document and may amend the settings of the eCSP accordingly. Then, the ECW decides in step 1307 whether the document is rejected according to step 1308 or whether the document is again entered into the system. If the examination step 1303 reveals no failure, a workflow is started in step 1309.

The predefined workflow process sends automatically an email to a first case worker (CW1), the email comprising a link to a structured document 1302a, which may be specifically designed for CW1. The CW1 applies the link and the structured document is opened and presented to him by his web browser. The CW1 edits in step 1311 the further data fields presented to him and thereby may add data to the structured document 1302a. The CW1 further may notify the workflow process whether the document has to be rejected or not. After closing the structured document 1302a, the workflow may notice in step 1312, e.g. by supervision of the status of the document 1302a or the information contained in it, that the process step 1311 has been completed. If in step 1313 the document 1302a is still ok, a second caseworker (CW2) is called in step 1314. Otherwise the document is rejected by step 1308. The predefined workflow process may automatically send an email to CW2, the email comprising a link to a structured document 1302b, which may be specifically designed for CW2. The CW2 applies the link and the structured document is opened and presented to him by his web browser. The CW2 edits in step 1315 the further data fields presented to him and thereby may add data to the structured document 1302b. The CW2 further may notify the workflow process whether the document has to be rejected or not. After closing the structured document 1302b, the workflow notices in step 1316, e.g. by supervision of the status of the document 1302b or the information contained in it, that the process step 1315 has been completed. If in step 1317 the document 1302b is still ok, a controller is called in step 1318. Otherwise the document is rejected by step 1308. The predefined workflow process may automatically send an email to the controller, the email comprising a link to a structured document 1302c, which may be specifically designed for the controller. The controller applies the link and the structured document is opened and presented to him by his web browser. The controller reviews in step 1319 the document 1302c and notifies the workflow process whether the document has to be rejected or not. After closing the structured document 1302c, the workflow notices in step 1320, e.g. by supervision of the status of the document 1302c or the information contained in it, that the process step 1315 has been completed. If in step 1321 the document 1302c is still ok, an adapted document (accounting voucher) is created from the accepted document and sent to the second party (customer). Otherwise, depending on the decision of the controller, the document is rejected by step 1308 or reentered into the system. The process ends in step 1323.

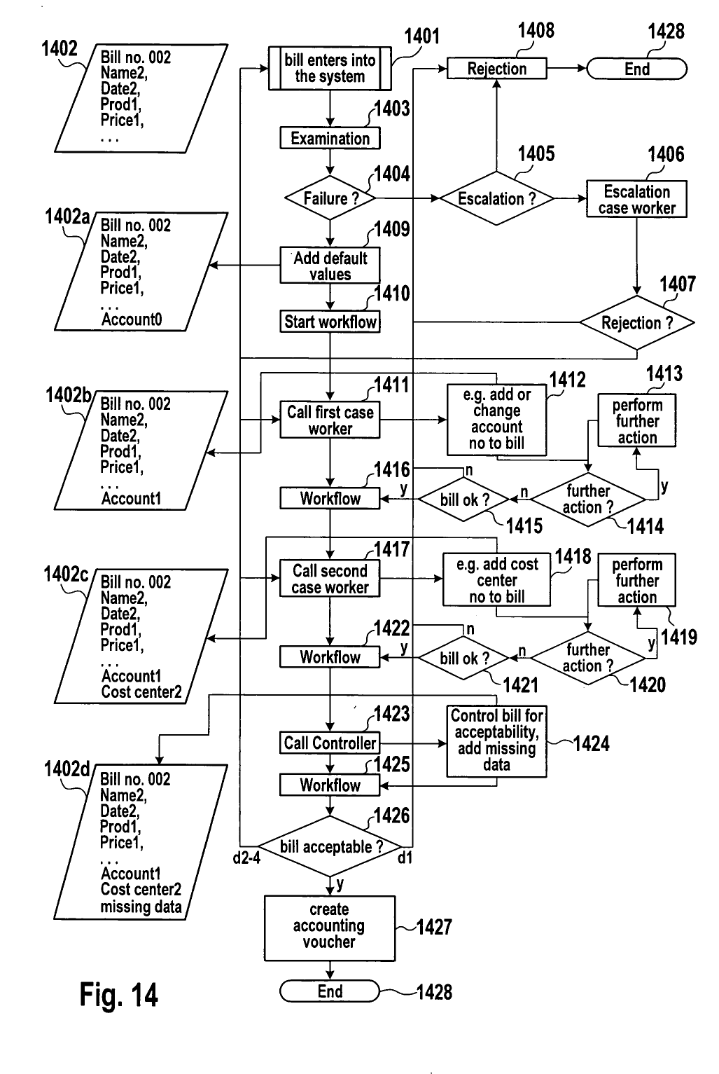

FIG. 14 shows a further example of a process for processing an electronic document, e.g. an invoice, alternatively referred to as bill. The process starts at step 1401 when document is entered into the system. The eCSP performs an examination step 1403, in which the received document is reviewed according to preset rules whether it fulfills predefined conditions. The eCSP also creates a structured document 1402 including all or part of the data fields of the incoming document and further data fields. If the examination reveals a failure an escalation may be initiated according to decision steps 1404 and 1405. In case no escalation procedure shall be initiated, which decision may be automatically performed by the eCSP according to predefined rules, the document is rejected in step 1408 by sending a corresponding email to the sender of the document. This may be performed automatically by the eCSP according to predefined emails, depending on the kind of the failure. In case an escalation procedure is initiated, an email comprising a link to a structured document 1402, which may be specifically designed for the escalation situation, is automatically send to an escalation case worker (ECW) in step 1406. The ECW may negotiate the case with the sender of the document and may amend the settings of the eCSP accordingly. Then, the ECW decides in step 1407 whether the document is rejected according to step 1408 or whether the document is again entered into the system. If the examination step 1403 reveals no failure, the eCSP may store default values into the further data fields contained the structured document 1402 thus creating a structured document 1402a. Subsequently, a workflow is started in step 1410.

The predefined workflow process may automatically send an email to a first case worker (CW1), the email comprising a link to a structured document 1402b, which may be specifically designed for CW1 out of document 1402a. The CW1 applies the link and the structured document is opened and presented to him by his web browser. The CW1 edits in step 1412 the further data fields presented to him and thereby may add data to the structured document 1402b or changes the default values or selects values from a presented list. The CW1 decides in step 1414 whether a further action shall be performed by a further caseworker and if yes, CW1 may send a corresponding email including the link to the further caseworker, who then performs the action in step 1413. The CW1 further decides in step 1415 whether the document has to be rejected or not. In case yes, the document is rejected according to step 1408. After closing the structured document 1402b, the workflow notices in step 1416, e.g. by supervision of the status of the document 1402b or the information contained in it, that the process step 1412 has been completed. If the document is not rejected, a second caseworker (CW2) is called in step 1417.

The workflow process may automatically send an email to CW2, the email comprising a link to a structured document 1402c, which may be specifically designed for CW1 out of document 1402b or identical to it. The CW2 applies the link and the structured document is opened and presented to him by his web browser. The CW2 edits in step 1418 the further data fields presented to him and thereby adds data to the structured document 1402c or changes the default values or selects values from a presented list. The CW2 decides in step 1420 whether a further action shall be performed by a still further caseworker and if yes, CW2 may send a corresponding email including the link to the still further caseworker, who then performs the action in step 1419. The CW2 further decides in step 1421 whether the document has to be rejected or not. In case yes, the document is rejected according to step 1408. After closing the structured document 1402c, the workflow notices in step 1422, e.g. by supervision of the status of the document 1402c or the information contained in it, that the process step 1418 has been completed. If the document is not rejected, a controller is called in step 1423.

The workflow sends automatically an email to the controller, said email comprising a link to a structured document 1402d, which may be specifically designed for the controller. The controller applies the link and the structured document is opened and presented to him by his web browser. The controller reviews in step 1424 the document 1402d, may add eventually missing data and notify the workflow process whether the document has to be rejected or not. After closing the structured document 1402d, the workflow notices in step 1425, e.g. by supervision of the status of the document 1402d or the information contained in it, that the process step 1424 has been completed. If in step 1426 the document 1402d is marked as acceptable, an adapted document (accounting voucher) is created from the accepted document and sent to the second party (customer). Otherwise, depending on the decision of the controller, the document is rejected by step 1408 or reentered into the system or resent to CW1 or CW2. The process ends in step 1428.

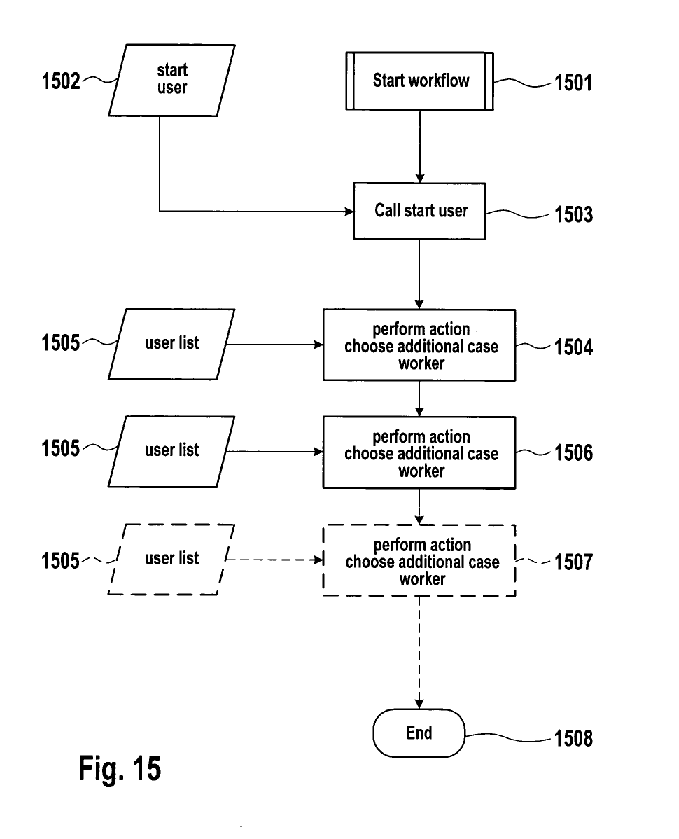

FIG. 15 shows an example of a further implementation of a workflow for the disclosed document processing method according to an exemplary implementation of the invention. The workflow starts in a step 1501, e.g. it is initiated by the eCSP who noticed an incoming document. A start user is selected from a document 1502. This may be the incoming document, which may include a data field, in which the name of a start user is contained. The workflow may automatically send an email to the start user in step 1503, the email comprising a link to a structured document, which may be specifically designed for the start user. The start user applies the link and the structured document is opened and presented to him by his web browser. The start user performs a specific action on the structured document in step 1504. After completion of the action, the start user may select an additional case worker from a user list 1505 and pass to him the structured document by sending an email comprising the link as already pointed out above. The additional case worker then performs an action in step 1506 and may select a further additional case worker from user list 1505 for performing a further action on the structured document. This procedure may be repeated as the case requires, indicated by step 1507 in dashed lines. If all actions have been performed, the workflow ends in step 1508.

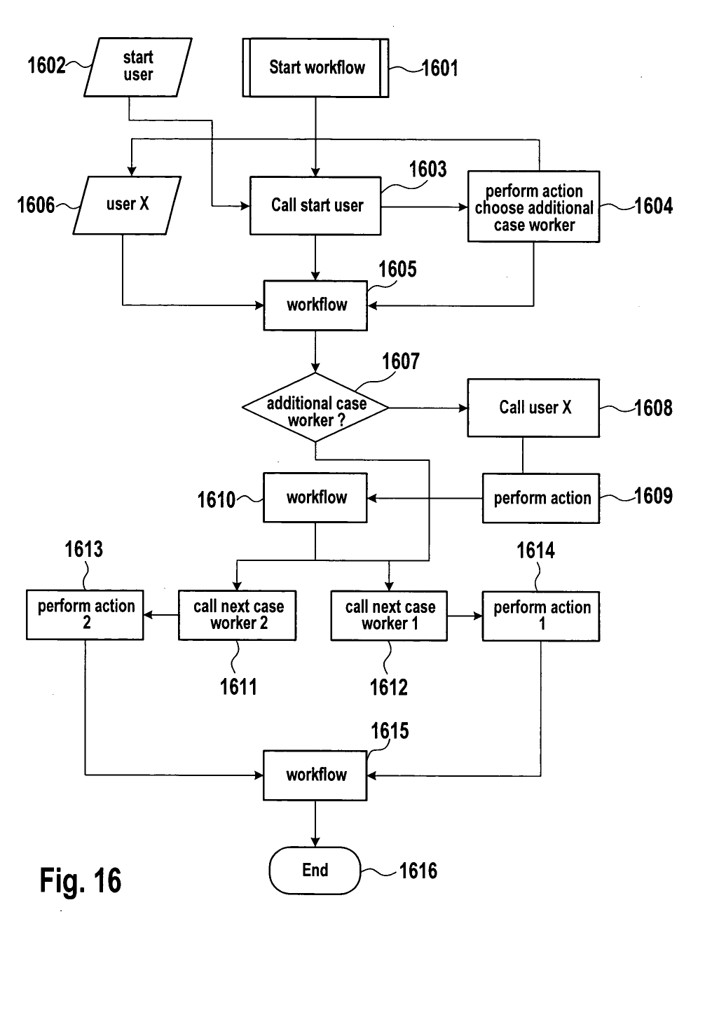

FIG. 16 shows a example of a still further implementation of a workflow for the disclosed document processing method according to an exemplary implementation of the invention. The workflow starts in a step 1601, e.g., it is initiated by the eCSP who noticed an incoming document. A start user is selected from a document 1602. This may be the incoming document, which may include a data field, in which the name of a start user is contained. The workflow may automatically send an email to the start user in step 1503, the email comprising a link to a structured document, which may be specifically designed for the start user. The start user applies the link and the structured document is opened and presented to him by his web browser. The start user performs a specific action on the structured document in step 1604. After completion of the action, the start user may select an additional case worker “user X” and store the address of user X in a document 1606. The start user closes the structured document. The workflow checks in steps 1605 and 1607 whether a additional case work is selected, e.g. by checking document 1606, and if yes, calls user X in step 1608 by sending him an email as pointed out above. User performs the action in step 1609. If no additional caseworker is selected, the workflow calls from step 1607 then next case workers 1 and 2 in step 1612, 1611, respectively. This is an example of a workflow with working steps running parallel. The next case workers 1 and 2 perform their respective actions in steps 1614, 1613. The workflow waits in step 1615 until the actions have all been performed and ends then in step 1616.

The disclosed method further comprises in a further embodiment archiving the electronic bills according to the following principles:

Archiving should meet the requirements of applicable regulations (VAT). The biller receives an archive in form of a non-erasable storage means such as CD or DVD ROM or an other read only device, that contains all his business transactions (bills) with the eCSP. The customer may also receive an archive, in the same form as the biller, containing all his business transactions with the eCSP. The archive may comprise:

An Index, digitally signed by the provider running the eCSP, wherein the index contains invoice summaries of all the business transactions in the archive. The index may be digitally signed to have a proof of the archive content (Business Transactions cannot be removed) for every business transaction (invoice presented) and may comprise:

A business transaction report containing the invoice summary, a history of all business transaction events and hyperlinks to the original messages.

All messages exchanged, e.g. the digitally signed invoice as a structured message (XML IDOC or EDIFACT, etc.), the invoice as PDF File also digitally signed, etc.

Optionally, cryptographic mechanisms are applied, to avoid any changes of the content of the archive. The archive may be produced periodically, according to the requirements of the biller or customer. The archive can be delivered to the biller or the customer. The receiver can confirm readability of the received archive by sending an “archive accepted” message or by interactive confirmation of the acceptance. Business transactions may be removed from the eCSP after receiving all necessary acceptance messages and after a configurable number of working days (typically 90).

The disclosed method system as described solves requirements on EBPP system such as: easy integration of biller- and customer IT systems, consolidation of bills of different billers for one customer, allowance for multiple financial institutions for payment, access security and privacy of invoice details, compliance to national government VAT regulations, high scalability with respect to invoice volume, allowance for cross border EBPP, and invoice review workflow. Minimum afford for IT systems on the customer side, because a customer needs only a computer system and a web browser.

Modifications and adaptations of the present invention will be apparent to those skilled in the art from consideration of the specification and practice of the invention disclosed herein. The foregoing description of an implementation of the invention has been presented for purposes of illustration and description. It is not exhaustive and does not limit the invention to the precise form disclosed. Modifications and variations are possible in light of the above teachings or may be acquired from the practicing of the invention. For example, the described implementation includes software, but systems and methods consistent with the present invention may be implemented as a combination of hardware and software or in hardware alone. Additionally, although aspects of the present invention are described for being stored in memory, one skilled in the art will appreciate that these aspects can also be stored on other types of computer-readable media, such as secondary storage devices, for example, hard disks, floppy disks, or CD-ROM; the Internet or other propagation medium; or other forms of RAM or ROM.

Computer programs based on the written description and flow charts of this invention are within the skill of an experienced developer. The various programs or program modules can be created using any of the techniques known to one skilled in the art or can be designed in connection with existing software. For example, programs or program modules can be designed in or by means of Java, C++, HTML, XML, or HTML with included Java applets or in SAP R/3 or ABAP. One or more of such modules can be integrated in existing e-mail or browser software.

While illustrative embodiments of the invention have been described herein, the present invention is not limited to the various preferred embodiments described herein, but includes any and all embodiments having equivalent elements, modifications, omissions, combinations (e.g., of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive. For example, in the present disclosure, the term “preferably” is non-exclusive and means “preferably, but not limited to.” Means-plus-function or step-plus-function limitations will only be employed where for a specific claim limitation all of the following conditions are present in that limitation: a) “means for” or “step for” is expressly recited; b) a corresponding function is expressly recited; and c) structure, material or acts that support that structure are not recited.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method for processing an electronic document, wherein the document comprises a plurality of data fields and wherein the document is made accessible by a first party to a second party via a computer network, comprising:
enabling a second party to add one or more further data fields to one or more of the data fields of the document.

2. The method of claim 1, further comprising:
enabling said second party to enter information into the one or more further data fields.

3. The method of claim 2,, further comprising:
providing, by the first party, proposals for the information to the second party according to a predefinable list.

4. The method of claim 1, wherein the document is an electronic bill.

5. The method of claim 4, further comprising:
writing, by the first party, financial information into the one or more further data fields and adding the one or more further data fields to the electronic bill.

6. The method of claim 5, further comprising:
selecting the financial information from the group consisting of financial objects, accounting objects, and bookkeeping objects.

7. The method of claim 1, further comprising:
writing a predefinable value into one or more of the further data fields.

8. The method of claim 1, wherein enabling said second party to add one or more further data fields to one or more of the data fields of the document comprises providing one or more structured documents.

9. The method of claim 8, wherein the structured document comprises data and/or tags and/or program code and wherein the structured document is accessible by the second party.

10. The method of claim 8, wherein at least one of the structured documents is a structured table, an XML-file, a HTML-file, or a java server page.

11. The method of claim 4, further comprising:
enabling the second party to characterize the bill as accepted or refused.

12. The method of one claim 11, further comprising:
sending an accepted electronic bill to the second party and/or to a payment service provider.

13. The method of claim 12, further comprising:
creating an accounts record from an accepted bill and sending it to the second party.

14. The method of claim 1, wherein two or more of the further data fields are structured hierarchical.

15. The method of claim 1, further comprising:
assigning to one or more of the further data fields a property selected from the group consisting of displayable, non-displayable, optionally editable, and mandatory editable.

16. The method of claim 1, further comprising:
naming the one or more further data fields by the first party.

17. The method of claim 1, further comprising:
checking an authorization of a user of the second party.

18. The method of claim 1, further comprising:
making the document accessible to the second party by means of an intranet or the Internet.

19. The method of claim 1, further comprising:
counting the documents and providing an invoice for the processing of the documents to the second party.

20. The method of claim 4, further comprising:
automatically starting a workflow for processing the bill if an electronic bill is received from a third party.

21. The method of claim 20, further comprising:
sending an electronic notice, which includes a link to the document to an address contained in the workflow.

22. The method of claim 20, wherein the workflow runs according to a predefinable sequence.

23. The method of claim 20, further comprising:
automatically checking an authorization of a participant of the workflow.

24. The method of claim 1, wherein the method is for use with an enterprise accounting system.

25. A computer system for processing an electronic document, wherein the document comprises a plurality of data fields and wherein the document is made accessible by a first party to a second party via a computer network, comprising:
memory having program instructions;
input means for receiving and entering data;
output means for sending and presenting data;
storage means for storing data; and
a processor responsive to the program instructions, said program instructions comprising program code means for performing a method according to any one of claims 1 to 23.

26. The computer system of claim 25, wherein the computer system is for use with an enterprise accounting system.

27. A computer system for processing an electronic bill, comprising:
memory having program instructions;
input means for receiving and entering data;
output means for sending and presenting data;
storage means for storing data; and
a processor responsive to the program instructions,
wherein a method according to claim 1 is performed to process the electronic bill when said program instructions are executed by said processor.

28. A computer readable medium comprising instructions for processing an electronic document, wherein the document comprises a plurality of data fields and wherein the document is made accessible by a first party to a second party via a computer network, said instructions comprising instructions for:
enabling a second party to add one or more further data fields to one or more of the data fields of the document.

29. The computer readable medium of claim 28, further comprising instructions for:
enabling said second party to enter information into the one or more further data fields.

30. The computer readable medium of claim 28, further comprising instructions for:
enabling said first party to provide proposals for the information to the second party according to a predefinable list.

31. The computer readable medium of claim 28, wherein the document is an electronic bill.

32. The computer readable medium of claim 31, further comprising instructions for:
enabling said first party to write financial information into the one or more further data fields and add the one or more further data fields to the electronic bill.

33. The computer readable medium of claim 32, further comprising instructions for:
selecting the financial information from the group consisting of financial objects, accounting objects, and bookkeeping objects.

34. The computer readable medium of claim 28, further comprising instructions for:
writing a predefinable value into one or more of the further data fields.

35. The computer readable medium of claim 28, wherein the instructions for enabling said second party to add one or more further data fields to one or more of the data fields of the document comprises instructions for providing one or more structured documents.

36. The computer readable medium of claim 35, wherein the structured document comprises data and/or tags and/or program code and the structured document is accessible by the second party.

37. The computer readable medium of claim 35, wherein at least one of the structured documents is a structured table, an XML-file, a HTML-file, or a java server page.

38. The computer readable medium of claim 31, further comprising instructions for:
enabling the second party to characterize the bill as accepted or refused.

39. The computer readable medium of claim 38, further comprising instructions for:
sending an accepted electronic bill to the second party and/or to a payment service provider.

40. The computer readable medium of claim 39, further comprising instructions for:
creating an accounts record from an accepted bill and sending it to the second party.

41. The computer readable medium of claim 28, further comprising instructions for:
hierarchically structuring two or more of the further data fields.

42. The computer readable medium of claim 28, further comprising instructions for:
assigning to one or more of the further data fields a property selected from the group consisting of displayable, non-displayable, optionally editable, and mandatory editable.

43. The computer readable medium claim 28, further comprising instructions for:
naming the one or more further data fields.

44. The computer readable medium of claim 28, further comprising instructions for:
checking an authorization of a user of the second party.

45. The computer readable medium of claim 28, further comprising instructions for:
making the document accessible to the second party by means of an intranet or the Internet.

46. The computer readable medium of claim 28, further comprising instructions for:
counting the documents and providing an invoice for the processing of the documents to the second party.

47. The computer readable medium of one or more of claim 31, further comprising instructions for:
automatically starting a workflow for processing the bill if an electronic bill is received from a third party.

48. The computer readable medium of claim 47, further comprising instructions for:
sending an electronic notice, which includes a link to the document, to an address contained in the workflow.

49. The computer readable medium claim 47, wherein the workflow runs according to a predefinable sequence.

50. The computer readable medium of claim 47, further comprising instructions for:
automatically checking an authorization of a participant of the workflow.

51. The computer readable medium according to any of claims 28 to 50, wherein the computer readable medium is for use with an enterprise accounting system.

52. The computer readable medium according to any one of claims 28 to 50, wherein the computer readable medium is a computer data signal embodied in a carrier wave.

53. A method for processing documents using a computer system, in which the document is available in electronic form with one or more data fields which contain document information, and in which method one or more electronic documents are made accessible to a second party by a first party via a computer network, the method comprising:
automatically providing one or more structured documents to the second party, which allows the second party to add one or more further data fields to one or more data fields in the or each electronic document.

54. The method of claim 53, wherein a reference to the storage location of the or each structured document is presented to the second party.

55. The method of claim 53, wherein the second party uses a network connection to access the structured document.

56. The method of claim 53, wherein the or each structured document contains data and/or tags and/or program code, so that the second party, which is accessing the structured document, is provided with a list of one or more data fields for selection and/or editing and/or addition.

57. The method of claim 53, wherein the structured document is a structured table, an XML file, an HTML file, or a Java Server Page.

58. The method of claim 53, wherein the second party uses a web browser to access the or each structured document over a network or the Internet.

59. The method of claim 53, wherein the structured document contains a reference to the storage location of the electronic document.

60. The method of claim 53, wherein the or each further data field is preallocated a default value.

61. The method of claim 53, wherein the second party is provided with means for inputting information into the or each further data field.

62. The method of claim 53, wherein the document is an invoice.

63. The method of claim 62, wherein the second party is provided with means for acknowledging the invoice.

64. The method of claim 53, further comprising sending the or each structured document to the second party.

65. The method of claim 53, wherein the electronic document and/or the structured document is encrypted.

66. The method claim 53, wherein a workflow for processing the or each structured document is started.

67. The method of claim 53, wherein the electronic document is automatically checked for presetable criteria.

68. The method of claim 53, wherein the electronic document and/or the structured document is digitally signed.

69. The method of claim 62, further comprising forwarding the invoice to a payment service.

70. The method according to any one of claims 61 to 69, wherein the information is invoice information and comprises information regarding addresses for the invoice issuer and/or for the invoice receiver and/or for the payment service and/or regarding payment and/or regarding VAT and/or regarding invoice items with respect to the underlying order and/or regarding commentary.

71. The method of claim 62, wherein the further data fields are provided for inputting account assignment information.

72. A method for processing a electronic document, stored in a computer system of a first party, by a second party, wherein the document comprises a plurality of data fields and wherein the document is made accessible by the first party to the second party via a computer network, the method comprising:
accessing one or more structured documents presented by the first party and adding and/or editing one or more further data fields to the electronic document by means of said one or more structured documents.

73. The method of claim 72, further comprising:
receiving a link to one of the structured documents.

74. The method of claim 72, further comprising:
accessing the one or more structured documents via a network.

75. The method of claim 72, wherein:
at least one of the structured documents comprise tags and/or program code, for enabling the second party to select one or more further data fields for editing and/or adding to the electronic document.

76. The method of claim 72, wherein:
at least one of the structured documents is a HTML- or XML-file, a structured table, or a Java Server Page.

77. The method of claim 72, wherein:
at least one of the structured documents contains a link to the electronic document.

78. The method of claim 72, wherein:
the electronic document is an invoice.

79. The method of claim 72, further comprising:
entering financial information into the one or more further data fields.

80. A computer system comprising:
memory comprising program instructions;
input means for receiving and entering data;
output means for sending and presenting data storage means for storing data; and
a processor responsive to the program instructions;
wherein the program instructions comprise program code means for carrying out a method as claimed according to any one of claims 53 to 69, or 71 to 79.

81. A computer program comprising program code means for executing all the steps in any method as claimed according to any one of claims 1 to 23, 53 to 69, or 71 to 79 when executed on a computer.

82. A computer program as claimed in claim 81, wherein the computer program is contained in an electrical carrier signal.
